(19) United States
(12) Patent Application Publication
(10) Pub. No.: US 2026/0340073 A1
(43) Pub. Date: Oct. 29, 2026

(54) SELF-ADJOINT RECOGNITION OPERATOR FOR PRIME-SPECTRAL ANALYTICS - METHODS, HARDWARE, AND COMPRESSION SYSTEMS FOR PARAMETER- FREE ZETA-ZERO ENUMERATION AND PRIME-INDEXED SPECTRAL CODECS

(71) Applicant: Jonathan Washburn, Austin, TX (US)

(72) Inventor: Jonathan Washburn, Austin, TX (US)

(21) Appl. No.: 19/655,088

(22) Filed: Apr. 22, 2026

Related U.S. Application Data
(60) Provisional application No. 63/794,528, filed on Apr. 25, 2025.

(51) Int. Cl. G06F 17/15

(52) U.S. Cl. CPC G06F 17/156

(57) ABSTRACT

A recognition-physics-derived spectral system generates ordered spectral values for number-theoretic computation, validation, and compression. A recognition cost function is transformed into a potential, and a spectral operator is constructed from the transformed potential and a kinetic term. The operator is realized in finite computational form and processed with an iterative eigensolver workflow to compute ordered spectral values. The spectral values may be compared with reference spectra, stored in spectral tables, or used in downstream processing. In some embodiments, prime-derived or integer-derived data are mapped to spectral-domain representations and compressed using entropy coding. Implementations may use structured matrix operations, refinement procedures, and accelerator hardware including GPU, FPGA, ASIC, photonic, quantum, distributed, or network-accessible platforms.

### CROSS-REFERENCE TO RELATED APPLICATIONS

This application claims the benefit of U.S. Provisional Patent Application No. 63/794,528, filed on Apr. 25, 2025. The foregoing provisional application is incorporated herein by reference in its entirety for all purposes not inconsistent with the present disclosure.

### BACKGROUND OF THE INVENTION

The present disclosure relates generally to computational spectral analysis, operator-based number-theoretic computation, hardware-accelerated eigensolvers, and compression systems for prime-indexed and spectrum-indexed data representations. More particularly, the present disclosure relates to recognition-physics-derived spectral operators, including self-adjoint operator realizations and related computational embodiments, for parameter-free or substantially parameter-free extraction, enumeration, comparison, and use of spectral values associated with number-theoretic structures, including spectral values corresponding to or associated with non-trivial zeta-zero ordinates, as well as to methods, hardware platforms, and codec systems that employ such operators and spectral values.

One longstanding objective in analytic number theory has been the identification of an explicit operator whose spectrum corresponds to the imaginary ordinates of the non-trivial zeros of the Riemann zeta function. This objective is commonly associated with Hilbert-Pólya-type programs, which generally seek an operator-theoretic realization of a zero spectrum in a form that is real, discrete where appropriate, and computationally accessible. Conventional proposals have faced substantial limitations. Some candidate constructions are abstract and non-constructive, some fail to provide a practically realizable self-adjoint operator on a suitable domain, and others require regularization choices, empirical boundary conditions, tuned parameters, or other externally imposed structures that narrow their applicability or reduce their usefulness for scalable computation.

At the same time, existing computational approaches for enumerating zeta-zero ordinates and related number-theoretic spectral quantities can be costly, difficult to scale, or poorly suited for unified implementation across software, accelerator, and codec workflows. Known approaches generally do not provide a single framework that simultaneously supports operator construction, high-throughput spectral extraction, validation against reference tables, and compression of prime-derived datasets using spectrum-domain representations. Existing systems also tend not to provide a unified path from an underlying cost functional to both a realizable spectral operator and a downstream data representation suitable for entropy coding or related compression workflows.

Recognition Science, referred to in certain embodiments herein as a recognition-physics-derived framework, provides a distinct derivational framework in which a recognition cost functional gives rise to a transformed potential and corresponding operator structures. In embodiments described herein, a recognition cost function J(X) is expressed as J(X)=½(X+1/X)−1, and under a logarithmic coordinate transform x=ln(X), the corresponding transformed potential may be written as V_RP(x)=J(e\hat{ }x)=cosh(x)−1. In disclosed embodiments, this transformed potential is used to construct a spectral operator, including in some embodiments a Schrödinger-type self-adjoint operator realization and, in other embodiments, related local, nonlocal, or effective-operator realizations. This framework provides a route to a confining spectral structure without reliance on shape-fitting of the potential itself and further supports implementations extending beyond a single exact local operator form.

The disclosed subject matter is also motivated by prime-stiffness and related recognition-physics number-theoretic structures in which prime-gap positivity, log-prime ordering, effective bandwidth structure, and associated rigidity or phase constraints motivate the use of operator-derived spectra as number-theoretic spectral objects, comparison targets, or computational surrogates. Whether used for direct correspondence, numerical comparison, model fitting, verification, compression, or other computational purposes, there remains a need for systems that can construct and use such spectra in a practical and scalable manner.

There is therefore a need for improved computational systems, methods, and hardware architectures capable of constructing recognition-physics-derived spectral operators, discretizing and solving such operators efficiently, extracting ordered spectral values at useful precision and throughput, validating such values against reference data or statistical criteria, and employing the resulting spectral values in prime-indexed or spectral-indexed encoding and decoding systems.

There is a further need for a disclosure broad enough to support multiple claim paths, including operator claims, spectral computation method claims, hardware and accelerator claims, compression and codec claims, computer-readable-medium claims, and generalized target-spectrum embodiments, without requiring later continuation-in-part practice merely to capture foreseeable implementations, boundary-condition variants, solver alternatives, nonlocal operator extensions, hardware deployments, or alternate target spectra.

### SUMMARY OF THE INVENTION

The present disclosure provides systems, methods, hardware platforms, and compression architectures based on a recognition-physics-derived spectral framework for parameter-free or substantially parameter-free zeta-zero enumeration and related prime-spectral analytics. In representative embodiments, a recognition cost function is used to generate a transformed potential and corresponding spectral operator structure, wherein the operator is configured to yield ordered spectral values that may be computed, refined, compared, validated, stored, transmitted, encoded, decoded, or otherwise used in connection with number-theoretic spectral analysis. In certain embodiments, the recognition cost function is expressed as J(X)=½(X+1/X)−1, and under a logarithmic coordinate transform x=ln(X), a transformed potential is expressed as V_RP(x)=J(e\hat{ }x)=cosh(x)−1, thereby enabling construction of a confining spectral operator that, in some embodiments, is realized as a self-adjoint Schrödinger-type operator and, in other embodiments, is realized as an equivalent or related local, nonlocal, discrete, truncated, transformed, or effective operator.

In some embodiments, the disclosed subject matter provides a computational spectral system configured to construct, store, access, discretize, or otherwise realize a recognition-derived operator on a selected domain, including but not limited to half-line domains, full-line domains, truncated computational domains, matrix realizations, basis-projected realizations, and boundary-conditioned self-adjoint realizations. In certain embodiments, the operator includes a kinetic term and a local potential term. In further embodiments, the operator additionally includes or is associated with a nonlocal term, integral kernel term, Toeplitz-structured term, low-rank correction term, convolutional term, or functionally equivalent matrix component. In some embodiments, the disclosed systems thereby support both exact local formulations and broader operator-family formulations while preserving a common computational workflow for spectral extraction.

In some embodiments, the present disclosure provides numerical methods for computing ordered spectral values from the disclosed operator structures. Such methods may include discretization of the operator on a logarithmic grid, adaptive grid, uniform grid, nonuniform grid, finite-difference stencil, finite-element basis, spectral basis, Galerkin basis, or other computational representation, followed by iterative eigensolution using Krylov-subspace methods, Lanczos methods, block Lanczos methods, Rayleigh-quotient refinement, shift-invert methods, contour-based methods, matrix-free methods, or other direct or iterative solver techniques. In certain embodiments, matrix-vector products are accelerated using Toeplitz structure, FFT-based transforms, cached coefficients, shared-memory reuse, low-rank compression, batch processing, or parallel hardware execution. In some embodiments, the resulting spectral values are output as ordered ordinates, stored in spectral tables, used for index-based retrieval, or supplied to downstream validation, comparison, or compression pipelines.

In some embodiments, the disclosed systems are configured to compare or associate the computed spectral values with number-theoretic spectra, including spectra corresponding to non-trivial zeta-zero ordinates, Dirichlet L-function zeros, Maass-form-related spectra, automorphic spectra, or other target spectral structures. In certain embodiments, comparison may include index-based comparison, window-based comparison, relative-error analysis, count matching, spacing analysis, rigidity analysis, number-variance analysis, or other statistical or reference-based validation techniques. In this way, the disclosed framework supports not only spectral computation, but also verification and analytical use of the resulting spectral data.

In some embodiments, the disclosure further provides prime-spectral compression systems and codecs in which prime-indexed, factorization-derived, or integer-derived data are transformed into spectral-domain or spectral-gap-domain representations for encoding. In certain embodiments, an input sequence is factorized or otherwise mapped to prime indices, the prime indices are mapped to corresponding spectral positions or spectral values, transformed values such as spectral gaps, residuals, or higher-order deltas are generated, and the transformed values are encoded using arithmetic coding, range coding, entropy coding, or related lossless coding techniques. In further embodiments, decoding performs inverse entropy decoding, inverse spectral reconstruction, inverse mapping, and reconstruction of the original integer-derived data.

In this manner, the disclosed subject matter provides a unified framework in which a recognition-derived spectral structure is used both for spectral computation and for compression of prime-derived data streams.

In some embodiments, spectral values used in downstream lookup, validation, or codec workflows are obtained from a stored spectral table generated from the disclosed spectral operator and optionally marked with validation metadata indicating whether one or more acceptance criteria have been satisfied. In certain embodiments, decoding further includes one or more reconstruction checks so that a decoded output is marked valid only when the reconstructed data satisfy a selected lossless-reconstruction condition.

In some embodiments, the disclosed systems are implemented in hardware or hybrid software-hardware form, including GPU systems, FPGA systems, ASIC systems, CPU clusters, distributed-computing platforms, network-accessible services, photonic systems, quantum systems, and hybrid analog-digital or classical-quantum systems. In certain embodiments, hardware acceleration is used for operator assembly, matrix-vector multiplication, Krylov-subspace generation, block parallel eigensolution, refinement, verification, codec execution, or table-based lookup and reconstruction. In some embodiments, the disclosed subject matter is embodied as a standalone apparatus, a server system, a cloud service, a workstation implementation, a software package, or a non-transitory computer-readable medium storing instructions that, when executed, cause one or more processors to perform the disclosed methods.

In some embodiments, the disclosed subject matter improves computer-implemented spectral extraction by exploiting structure of the realized operator so that repeated operator applications use sparse-local terms together with structured nonlocal terms, including Toeplitz or low-rank terms, thereby reducing memory traffic, reducing repeated arithmetic cost, and improving throughput in iterative eigensolver workflows relative to unstructured dense-matrix implementations. In certain embodiments, the same structured spectral representation is reused across validation, lookup-table generation, and codec workflows, thereby providing a unified computational architecture rather than separate unrelated processing pipelines.

In some embodiments, the present disclosure further encompasses generalized recognition-operator and effective-Hamiltonian embodiments in which a discrete recognition evolution rule gives rise to an effective spectral operator under a small-strain, continuum, quadratic, or related approximation, thereby preserving support for implementations that are not limited to a single exact differential form. Accordingly, the present disclosure is directed not merely to one isolated mathematical expression, but to a broader family of recognition-derived spectral systems that support operator construction, spectral computation, validation, hardware acceleration, and prime-spectral compression within a common technical architecture.

### BRIEF DESCRIPTION OF THE DRAWINGS

The foregoing and other features and advantages of the present disclosure will become more apparent from the following detailed description, taken in conjunction with the accompanying drawings, in which like reference numerals identify like elements, and in which:

FIG. 1 is a schematic diagram of an overall spectral computation system 100 including a cost derivation module 102, a transform module 104, an operator construction module 106, a discretization module 108, an eigensolver module 110, a verification module 112, a codec module 114, an accelerator interface 116, and an output interface 118.

FIG. 2 is a schematic diagram of operator derivation and operator structure 200 including a composition-law input 202, a J-cost generator 204, a logarithmic transform 206, a transformed potential output 208, a kinetic term 210, a local potential term 212, a nonlocal term 214, a Toeplitz kernel 216, a low-rank component 218, and an assembled operator 220.

FIG. 3 is a schematic diagram of domain and boundary embodiments 300 including a half-line domain 302, a full-line domain 304, a truncated computational domain 306, a Dirichlet boundary condition 308, a Neumann boundary condition 310, a Robin boundary condition 312, a mixed boundary condition 314, a Friedrichs-extension embodiment 316, and a self-adjoint domain specification 318.

FIG. 4 is a schematic diagram of a numerical solver and acceleration workflow 400 including a grid construction stage 402, a discretization stage 404, an initial vector stage 406, a Krylov subspace stage 408, a Lanczos recursion stage 410, a reorthogonalization stage 412, a Ritz extraction stage 414, a refinement stage 416, a Toeplitz/FFT acceleration stage 418, a convergence test 420, and a spectral output buffer 422.

FIG. 5 is a schematic diagram of a verification and spectral correspondence workflow 500 including a computed spectrum input 502, a reference spectrum input 504, an alignment engine 506, an error engine 508, a spacing-statistics engine 510, a rigidity engine 512, a spectral index 514, a computed ordinate 516, a reference ordinate 518, a count-matching module 520, and a certification output 522.

FIG. 6 is a schematic diagram of a prime-spectral codec system 600 including an input sequence 602, a factorization module 604, a prime-index mapper 606, a spectral lookup 608, a transform stage 610, an entropy coder 612, a compressed output 614, a compressed input 616, an entropy decoder 618, a spectral reconstructor 620, an inverse mapper 622, an integer reconstruction module 624, and a decoded output 626.

FIG. 7 is a schematic diagram of hardware and deployment embodiments 700 including a GPU server 702, an FPGA accelerator 704, an ASIC implementation 706, a shared memory region 708, an FFT engine 710, a batch-eigensolver architecture 712, a photonic system 714, a quantum processor 716, a network interface 718, a client system 720, a storage subsystem 722, and a cloud or distributed-computing environment 724.

### DETAILED DESCRIPTION OF THE INVENTION

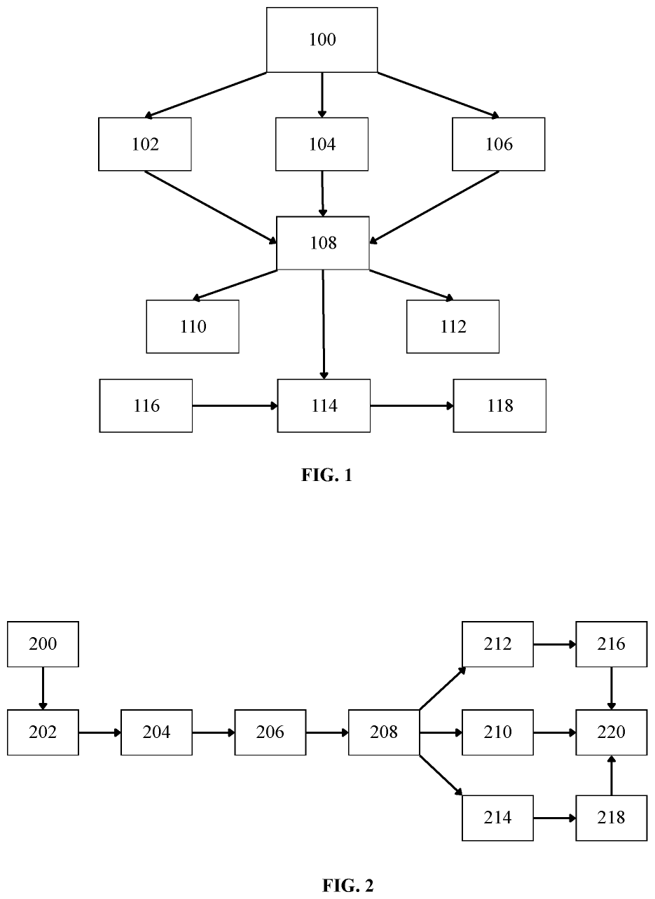

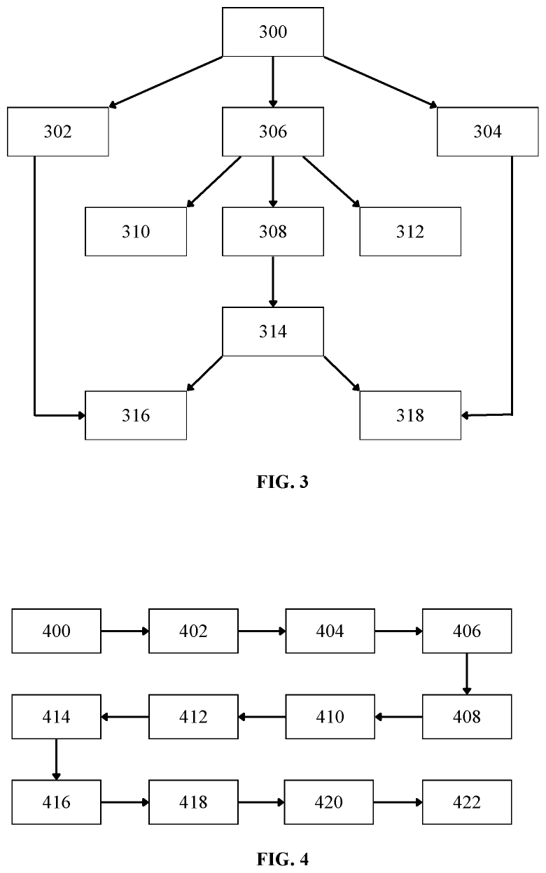

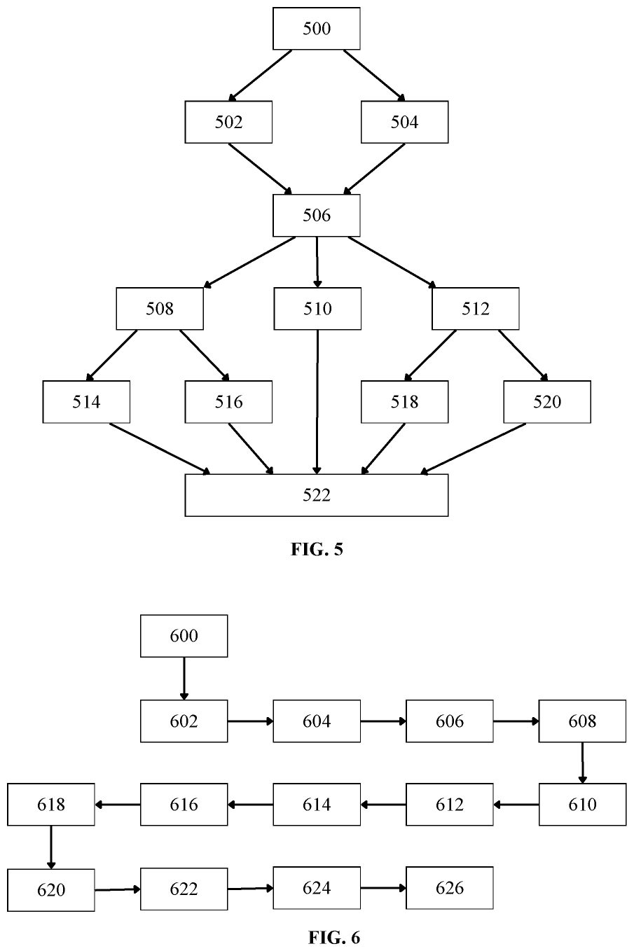

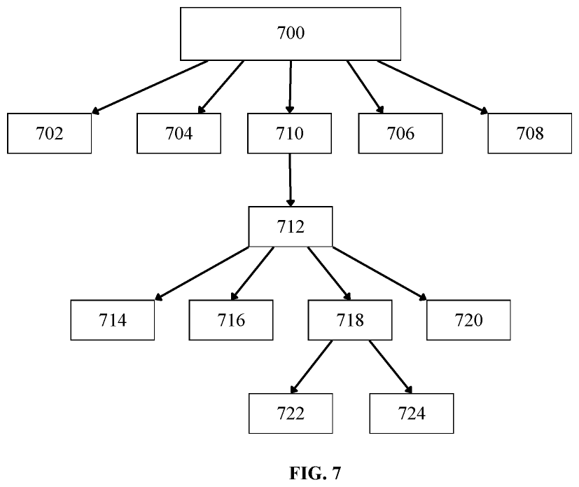

In the following detailed description, numerous specific details are set forth in order to provide a thorough understanding of the disclosed subject matter. It will be understood, however, by one of ordinary skill in the art that the disclosed subject matter may be practiced in other embodiments that depart from these specific details while remaining within the scope of the present disclosure. Accordingly, the embodiments described herein are illustrative and not limiting. The present disclosure is directed to recognition-physics-derived spectral systems, methods, hardware platforms, and compression architectures for parameter-free or substantially parameter-free zeta-zero enumeration, prime-spectral analytics, and prime-indexed spectral codecs, including but not limited to embodiments implemented through an overall spectral computation system 100 as shown in FIG. 1, an operator derivation and structure arrangement 200 as shown in FIG. 2, domain and boundary embodiments 300 as shown in FIG. 3, a numerical solver and acceleration workflow 400 as shown in FIG. 4, a verification and spectral correspondence workflow 500 as shown in FIG. 5, a prime-spectral codec system 600 as shown in FIG. 6, and hardware and deployment embodiments 700 as shown in FIG. 7.

For clarity and consistency, certain terms are used in a specific manner throughout this specification. As used herein, the term “recognition cost function” refers to a cost expression associated with recognition-physics structure and, in certain embodiments, is given by J(X)=½(X+1/X)−1, where X is a positive variable or ratio quantity. As used herein, the term “logarithmic coordinate” refers to a transformed coordinate x defined by x=ln(X). As used herein, the term “transformed potential” refers to a potential obtained from the recognition cost function under a coordinate transform and, in certain embodiments, is given by V_RP(x)=J(e\hat{ }x)=cosh(x)−1. As used herein, the term “spectral operator” refers to an operator, matrix realization, effective operator, or computationally equivalent structure configured to yield ordered spectral values. As used herein, the term “self-adjoint realization” refers to a realization of an operator on a selected domain and with selected boundary conditions such that the realization is self-adjoint or otherwise possesses the real-spectral and computational properties associated with a self-adjoint form. As used herein, the term “effective Hamiltonian” refers to an operator representation arising in an effective, approximate, reduced, continuum, or small-strain form of a broader recognition-operator framework. As used herein, the term “spectral ordinate” refers to an ordered spectral value, whether obtained from an analytical expression, numerical solver, matrix realization, approximation, refinement process, or lookup structure. As used herein, the term “reference spectrum” refers to comparison data, target data, validation data, or another spectrum against which computed spectral values may be aligned, compared, or statistically analyzed. As used herein, the term “prime index” refers to an index associated with a prime number, a prime-derived object, or a factorization-derived object. As used herein, the term “prime-spectral mapping” refers to a mapping between prime-related information and spectral values, spectral positions, or spectral transforms. As used herein, the term “nonlocal term” refers to an operator contribution that is not limited to a strictly pointwise local potential contribution and may include an integral-kernel term, a Toeplitz-structured term, a convolution term, a low-rank correction term, or another matrix or operator component having nonlocal coupling behavior. As used herein, the term “compression transform” refers to a transform, coding preparation step, or representation change used to render prime-derived, spectral-derived, or mixed data more suitable for entropy coding, range coding, arithmetic coding, or related lossless compression operations.

In certain embodiments, the overall spectral computation system 100 includes a cost derivation module 102, a transform module 104, an operator construction module 106, a discretization module 108, an eigensolver module 110, a verification module 112, a codec module 114, an accelerator interface 116, and an output interface 118. The cost derivation module 102 may receive, generate, evaluate, or otherwise access one or more recognition cost functions. The transform module 104 may transform the cost function into a selected coordinate representation, including a logarithmic coordinate representation. The operator construction module 106 may construct a spectral operator from one or more transformed quantities, including a potential term, a kinetic term, and in some embodiments one or more nonlocal or corrective terms. The discretization module 108 may generate a finite representation, basis representation, grid representation, matrix representation, or computational stencil for the operator. The eigensolver module 110 may compute ordered spectral values using one or more eigensolver workflows. The verification module 112 may compare computed spectral values to a reference spectrum or one or more target criteria. The codec module 114 may map prime-indexed, factorization-derived, or other integer-derived data into spectral-domain representations for compression or decompression. The accelerator interface 116 may provide access to GPU, FPGA, ASIC, photonic, quantum, or distributed-computing resources. The output interface 118 may output spectral values, verification metrics, compressed bitstreams, decoded data, reports, or related outputs.

With reference to FIG. 2, the operator derivation and structure arrangement 200 includes, in certain embodiments, a composition-law input 202, a J-cost generator 204, a logarithmic transform 206, a transformed potential output 208, a kinetic term 210, a local potential term 212, a nonlocal term 214, a Toeplitz kernel 216, a low-rank component 218, and an assembled operator 220. The composition-law input 202 represents data, rules, expressions, or functional relations from which a recognition cost function may be derived, instantiated, constrained, or evaluated. The J-cost generator 204 represents a process, module, or functional relation that generates or accesses a recognition cost function, including in certain embodiments J(X)=½(X+1/X)−1. The logarithmic transform 206 represents a coordinate transformation by which the variable X is transformed into x=ln(X). The transformed potential output 208 represents a transformed potential obtained after application of the transform, including in certain embodiments V_RP(x)=J(e\hat{ }x)=cosh(x)−1, which may also be written as V_RP(x)=½(e\hat{ }x+e\hat{ }(−x))−1. The kinetic term 210 represents a derivative-based or difference-based kinetic contribution, and the local potential term 212 represents a pointwise or diagonal potential contribution. The nonlocal term 214 represents an additional coupling structure that may be included in some embodiments. The Toeplitz kernel 216 represents a structured kernel or matrix contribution that may be constant along diagonals or otherwise compatible with transform-based acceleration. The low-rank component 218 represents a low-rank, compressed, approximate, or corrective structure. The assembled operator 220 represents a resulting spectral operator, matrix, or computational object formed from one or more of the foregoing components.

In certain embodiments, the disclosed operator may be written in a Schrödinger-type form. For example, in one embodiment, the operator may be expressed as H_RP psi(x)=−d\hat{ }2 psi(x)/dx\hat{ }2+V_RP(x)psi(x). In another equivalent expression, the operator may be written as H_RP psi(x)=−psi″(x)+(cosh(x)−1) psi(x). These expressions are representative and non-limiting. In some embodiments, the operator is realized directly in differential form. In some embodiments, the operator is realized in discretized matrix form. In some embodiments, the operator is realized as a truncated or basis-projected form. In some embodiments, the operator includes one or more additional nonlocal, kernel-based, weighted, shifted, or effective terms. In some embodiments, the disclosed subject matter includes an effective-Hamiltonian or related operator representation arising from a broader recognition-operator formulation. In such embodiments, small-strain, continuum, or approximation behavior may be described using a relation such as J(epsilon)=cosh(epsilon)−1=½ epsilon\hat{ }2+O(epsilon\hat{ }4), thereby supporting correspondence between a recognition-derived cost structure and an effective quadratic operator form in a local computational regime.

With reference to FIG. 3, the domain and boundary embodiment 300 includes, in certain embodiments, a half-line domain 302, a full-line domain 304, a truncated computational domain 306, a Dirichlet boundary condition 308, a Neumann boundary condition 310, a Robin boundary condition 312, a mixed boundary condition 314, a Friedrichs-extension embodiment 316, and a self-adjoint domain specification 318. As used herein, a “domain” refers to a function space, discrete index space, finite computational interval, basis subspace, matrix space, or other selected space on which an operator is defined or realized. A “boundary condition” refers to a constraint, rule, limiting value, derivative value, mixed condition, or equivalent computational condition imposed at one or more boundaries of the selected domain. A “self-adjoint domain specification” refers to a combination of operator form, domain, and boundary conditions selected so that the operator realization has self-adjoint properties or equivalent spectral behavior. A “Friedrichs-extension embodiment” refers to an embodiment in which the operator realization is obtained through a quadratic-form-based or extension-based construction compatible with a lower-bounded confining operator framework. These terms are used broadly so as to encompass analytical operator realizations, numerical realizations, and computationally equivalent approximations.

With reference to FIG. 4, the numerical solver and acceleration workflow 400 includes, in certain embodiments, a grid construction stage 402, a discretization stage 404, an initial vector stage 406, a Krylov subspace stage 408, a Lanczos recursion stage 410, a reorthogonalization stage 412, a Ritz extraction stage 414, a refinement stage 416, a Toeplitz/FFT acceleration stage 418, a convergence test 420, and a spectral output buffer 422. As used herein, “grid construction” refers to the generation of one or more coordinate grids, sampling grids, transformed grids, adaptive grids, or finite representations used in a numerical realization. “Discretization” refers to the process of converting an operator, equation, or other continuous or symbolic object into a finite-dimensional representation, including finite-difference, finite-element, spectral, Galerkin, matrix-free, or related computational approaches. “Krylov subspace” refers to a subspace generated through repeated operator action, and “Lanczos recursion” refers to a recursion-based eigensolver workflow suitable for symmetric or self-adjoint matrix realizations. “Ritz extraction” refers to extraction of approximate eigenvalues or spectral values from a reduced representation. “Refinement” refers to any post-processing or iterative process configured to improve spectral accuracy, including Rayleigh-quotient refinement or related methods. “Toeplitz/FFT acceleration” refers to a transform-assisted computational step used to accelerate matrix-vector products or kernel applications. These terms are used broadly to include exact implementations, approximate implementations, and equivalents thereof.

With reference to FIG. 5, the verification and spectral correspondence workflow 500 includes, in certain embodiments, a computed spectrum input 502, a reference spectrum input 504, an alignment engine 506, an error engine 508, a spacing-statistics engine 510, a rigidity engine 512, a spectral index 514, a computed ordinate 516, a reference ordinate 518, a count-matching module 520, and a certification output 522. As used herein, “computed spectrum” refers to one or more spectral values produced by the disclosed operator constructions and numerical workflows. “Reference spectrum” refers to one or more comparison values, tables, datasets, or statistical targets. “Alignment” refers to index-based matching, window-based matching, sorted matching, positional matching, or other comparison logic. “Error” refers to absolute error, relative error, residual error, or another comparison metric. “Spacing statistics” refers to gap distributions, nearest-neighbor spacing analysis, transformed spacing analysis, or other local statistical analyses on ordered spectral values. “Rigidity” refers to long-range statistical measures, including spectral rigidity or related number-variance or interval-count consistency measures. “Certification output” refers to a report, record, numerical output, pass/fail determination, or other validation product. In certain embodiments, spectral values are compared to data corresponding to non-trivial zeta-zero ordinates. In other embodiments, the comparison target is another target spectrum or a target statistical structure.

With reference to FIG. 6, the prime-spectral codec system 600 includes, in certain embodiments, an input sequence 602, a factorization module 604, a prime-index mapper 606, a spectral lookup 608, a transform stage 610, an entropy coder 612, a compressed output 614, a compressed input 616, an entropy decoder 618, a spectral reconstructor 620, an inverse mapper 622, an integer reconstruction module 624, and a decoded output 626. As used herein, “input sequence” refers to prime gaps, factorized integer sequences, prime-derived sequences, Goldbach-related data, twin-prime-related data, or other integer-derived data. “Factorization module” refers to a component configured to obtain prime factorizations, prime identifiers, prime-derived descriptors, or related indexing information. “Prime-index mapper” refers to a component configured to associate a prime, factor, or prime-derived object with a corresponding spectral index, spectral position, or spectral value. “Spectral lookup” refers to table lookup, search, interpolation, cache retrieval, or generated retrieval of one or more spectral values. “Transform stage” refers to generation of one or more transformed coding quantities, including spectral gaps, deltas, residuals, higher-order differences, or mixed coding symbols. “Entropy coder” and “entropy decoder” refer to arithmetic coding, range coding, ANS coding, Huffman coding, or equivalent lossless coding structures. “Inverse mapper” and “integer reconstruction module” refer to modules configured to reverse the codec pipeline and recover the original data or an equivalent lossless representation thereof.

With reference to FIG. 7, the hardware and deployment embodiment 700 includes, in certain embodiments, a GPU server 702, an FPGA accelerator 704, an ASIC implementation 706, a shared memory region 708, an FFT engine 710, a batch-eigensolver architecture 712, a photonic system 714, a quantum processor 716, a network interface 718, a client system 720, a storage subsystem 722, and a cloud or distributed-computing environment 724. As used herein, “hardware embodiment” refers to any machine, processor system, accelerator system, analog or digital system, or hybrid platform configured to implement one or more portions of the disclosed subject matter. “Deployment embodiment” refers to any local, remote, distributed, server-based, workstation-based, embedded, cloud-based, service-based, or network-accessible implementation. “Shared memory region” refers to on-chip, local, intermediate, or other fast-access memory usable to support solver or transform operations. “FFT engine” refers to fixed-function, programmable, or software-controlled transform logic. “Batch-eigensolver architecture” refers to a hardware or software-hardware arrangement configured to process multiple spectral computations concurrently or in pipelined form. “Photonic system” refers to an optical or wave-based realization of one or more operator, propagation, or spectral functions. “Quantum processor” refers to a system capable of implementing one or more quantum computational steps, including phase-estimation-type or Hamiltonian-simulation-type operations. These embodiments are illustrative and may be used individually or in combination.

Unless expressly stated otherwise, directional, positional, and relational terms such as input, output, upstream, downstream, local, nonlocal, forward, inverse, continuous, discrete, exact, effective, transformed, equivalent, corresponding, and associated are used for convenience in describing representative embodiments and are not intended to impose unnecessary structural or claim limitations. Likewise, references to zeta-zero ordinates, prime-spectral mappings, number-theoretic spectra, self-adjoint realizations, and parameter-free operation are intended to describe representative uses, derivations, and embodiments disclosed herein and should not be read as excluding computational equivalents, approximations, generalized target spectra, alternative operator families, or related solver and codec implementations unless such exclusion is expressly required by the claims. The disclosed subject matter is therefore to be understood as encompassing the structures and methods expressly described herein, as well as variations, substitutions, rearrangements, and computational equivalents that would be understood by one of ordinary skill in the art in view of the present disclosure.

In certain embodiments, the disclosed spectral systems are grounded in a recognition-physics derivation layer in which a recognition cost structure gives rise to a transformed potential and, from that transformed potential, to one or more spectral operator realizations. With reference to FIG. 1 and FIG. 2, the cost derivation module 102, the transform module 104, and the operator construction module 106 may cooperate to generate, transform, and realize a recognition-derived spectral operator from an underlying recognition cost function. In representative embodiments, the derivation begins from a recognition composition relation or equivalent generative relation represented by the composition-law input 202 and processed through the J-cost generator 204 to obtain a recognition cost function J(X). In certain embodiments, J(X) is expressed as J(X)=½(X+1/X)−1, where X is a positive variable, ratio quantity, scale quantity, or recognition-related quantity. This expression is useful because it is reciprocal in form, has a unique minimum at X=1, is non-negative for positive X, and provides a cost representation that is compatible with the transformed potential and operator structures disclosed herein.

In certain embodiments, the recognition cost function is transformed into a logarithmic coordinate system through the logarithmic transform 206. In one representative embodiment, the transformed coordinate is defined by x=ln(X). Under that transformation, the transformed potential output 208 may be expressed as V_RP(x)=J(e\hat{ }x)=cosh(x)−1. In an equivalent form, the transformed potential may be written as V_RP(x)=½(e\hat{ }x+e\hat{ }(−x))−1. These equivalent expressions are useful because they make explicit that the transformed potential is even in x, is non-negative, vanishes at x=0, and grows as |x| increases. In certain embodiments, this transformed potential provides the local potential term 212 used in the assembled operator 220. In other embodiments, the transformed potential serves as a generating structure for weighted, shifted, truncated, regularized, basis-projected, or otherwise modified operator forms.

In certain embodiments, the transformed potential has structural properties that support spectral computation. For example, because cosh(x) is an even function, V_RP(x) is symmetric under x mapped to −x. Because cosh(x) is greater than or equal to 1 for all real x, V_RP(x) is greater than or equal to 0. Because cosh(0)=1, the transformed potential attains a minimum value of zero at x=0. In certain embodiments, the transformed potential is strictly convex, and in certain embodiments the transformed potential is confining in the sense that it increases as |x|becomes large. Near the origin, the transformed potential may be approximated quadratically, while at larger magnitude it exhibits stronger-than-polynomial growth behavior associated with the hyperbolic cosine form. These properties are useful in supporting operator realizations having real, ordered, and computationally extractable spectral values.

In certain embodiments, the recognition-physics derivation layer supports construction of a Schrödinger-type operator. For example, using the kinetic term 210 and the local potential term 212, the assembled operator 220 may be expressed in one representative embodiment as H_RP psi(x)=−d\hat{ }2 psi(x)/dx\hat{ }2+V_RP(x) psi(x). In a corresponding explicit embodiment, the operator may be written as H_RP psi(x)=−psi″(x)+(cosh(x)−1) psi(x). These expressions are representative only. In other embodiments, the operator may be realized in matrix form, finite-dimensional form, transformed-coordinate form, basis form, or other computationally equivalent form. In still further embodiments, the nonlocal term 214, Toeplitz kernel 216, or low-rank component 218 may supplement or modify the local differential structure while preserving the underlying recognition-derived character of the operator family.

In certain embodiments, the recognition-physics derivation layer also supports a broader recognition-operator framework from which an effective Hamiltonian or related spectral operator may arise. In such embodiments, a recognition operator may govern discrete or stepwise evolution, and an effective spectral operator may be obtained under a local, small-strain, quadratic, or continuum approximation. In one representative approximation, the cost structure may be locally expanded according to J(epsilon)=cosh(epsilon)−1=½ epsilon\hat{ }2+O(epsilon\hat{ }4), thereby showing that the transformed recognition cost behaves quadratically for sufficiently small epsilon. In certain embodiments, this local quadratic behavior supports use of an effective Hamiltonian approximation, an effective local operator, or a reduced solver-compatible form even where the broader implementation is framed in recognition-operator terms rather than solely in differential-operator terms. This preserves support for embodiments that begin from a recognition evolution rule and embodiments that begin directly from a self-adjoint or equivalent spectral operator realization.

In certain embodiments, the derivation layer is further motivated by number-theoretic recognition-physics structures in which prime ordering, prime-gap positivity, bandwidth structure, rigidity constraints, and related recognition-physics relationships support use of the disclosed operator family as a source of spectral values for comparison with, association with, modeling of, or computation relative to number-theoretic spectra. In some embodiments, the ordered spectral values produced by the assembled operator 220 are used as candidate ordinates for comparison with non-trivial zeros of the Riemann zeta function. In other embodiments, the spectral values are used as computational surrogates, alignment targets, indexed reference values, compression-domain coordinates, or generalized target-spectrum values. Thus, the recognition-physics derivation layer is not limited to one interpretive use of the spectrum, but instead supports a broader technical architecture in which a recognition-derived cost structure yields a transformed potential, the transformed potential yields one or more operator realizations, and those operator realizations yield spectral values usable in computation, validation, and compression workflows.

In certain embodiments, the derivation layer is implemented in a manner that is parameter-free or substantially parameter-free with respect to the potential shape itself. That is, the transformed potential may be generated directly from the recognition cost function and the coordinate transform without empirical fitting of the basic potential form. In some embodiments, this does not exclude numerical parameters associated with discretization density, solver tolerances, truncation ranges, hardware precision, batching choices, memory layout, or other implementation details. Rather, in such embodiments, the parameter-free or substantially parameter-free character refers to the recognition-derived form of the transformed potential and related operator structure, as distinguished from approaches that rely on fitted potential-shape parameters, empirically selected correction profiles, or externally tuned spectral-shaping terms to define the basic operator. This distinction is useful for preserving clear support for both derivational embodiments and practical computational embodiments.

Accordingly, in certain embodiments, the recognition-physics derivation layer provides a technical bridge from a recognition cost expression to a transformed potential, from the transformed potential to a local or local-plus-nonlocal operator structure, and from that operator structure to ordered spectral values that may be extracted and used within the overall spectral computation system 100. The resulting derivation supports the subsequent domain and boundary embodiments described with respect to FIG. 3, the numerical solver and acceleration workflow 400 described with respect to FIG. 4, the verification and spectral correspondence workflow 500 described with respect to FIG. 5, the prime-spectral codec system 600 described with respect to FIG. 6, and the hardware and deployment embodiments 700 described with respect to FIG. 7.

In certain embodiments, the disclosed subject matter provides one or more operator constructions derived from the recognition-physics framework described above. With reference to FIG. 1 and FIG. 2, the operator construction module 106 may receive one or more outputs from the cost derivation module 102 and the transform module 104 and may generate an assembled operator 220 from the kinetic term 210, the local potential term 212, and, in some embodiments, one or more additional operator components including the nonlocal term 214, the Toeplitz kernel 216, and the low-rank component 218. The disclosed operator constructions are not limited to a single formal realization. Rather, in certain embodiments, the operator construction module 106 is configured to generate exact local operators, equivalent operator forms, weighted or shifted operator embodiments, local-plus-nonlocal operators, truncated or finite-dimensional realizations, and generalized target-spectrum operators, while preserving a common computational architecture for spectral extraction, verification, and codec use within the overall spectral computation system 100.

In one representative embodiment, the operator is constructed in a local Schrödinger-type form in which the transformed potential output 208 provides the local potential term 212 and the kinetic term 210 provides a second-derivative or equivalent kinetic contribution. In such an embodiment, the operator may be written as H_RP psi(x)=−d\hat{ }2 psi(x)/dx\hat{ }2+V_RP(x) psi(x), where V_RP(x)=J(e\hat{ }x)=cosh(x)−1. In an equivalent expression, the operator may be written as H_RP psi(x)=−psi″(x)+(cosh(x)−1) psi(x). In certain embodiments, this local form provides a primary or canonical realization of the disclosed operator family. In other embodiments, the same underlying operator may be represented using alternate notation, alternate coordinates, alternate basis functions, alternate scaling factors, or alternate computational representations without departing from the disclosed subject matter. Thus, references herein to the operator H_RP are intended to encompass exact symbolic expressions, equivalent transformed expressions, discretized forms, matrix realizations, and computationally equivalent forms derived from or associated with the same recognition-derived potential structure.

In certain embodiments, the operator construction is based on the transformed potential output 208 in a manner that preserves the structural properties of the recognition-derived cost transform. For example, the transformed potential may be used in direct form as V_RP(x)=cosh(x)−1. In another embodiment, the transformed potential may be used in an equivalent exponential form V_RP(x)=½(e\hat{ }x+e\hat{ }(−x))−1. In other embodiments, the operator construction module 106 may employ scaled forms, shifted forms, windowed forms, translated-coordinate forms, normalized forms, projected forms, or regularized forms of the transformed potential in order to facilitate numerical stability, finite-domain realization, large-index spectral targeting, or other practical computation. In certain embodiments, such modifications do not alter the underlying recognition-derived character of the operator, but instead provide implementation-specific constructions adapted to solver, hardware, or target-spectrum requirements. This is important because the present disclosure is intended to support not merely one exact symbolic equation, but also foreseeable computational realizations and equivalents that would be understood by one of ordinary skill in the art in view of the present disclosure.

In certain embodiments, the operator construction module 106 may also generate weighted or shifted operator embodiments. For example, the transformed coordinate x may be shifted, translated, or otherwise re-centered to facilitate extraction of spectral values in a selected range. In certain embodiments, a shifted operator may be used to target a selected spectral window, a selected height region, a selected computational band, or a selected reference range. In some embodiments, one or more scaling factors may be applied to coordinate variables, operator coefficients, basis parameters, or matrix entries to optimize numerical conditioning or hardware execution. In certain embodiments, the operator construction may further include additive or multiplicative correction structures used to represent equivalent recognition-derived behavior in a finite-dimensional, banded, sparse, low-rank, or mixed local/nonlocal computational form. These weighted, shifted, and transformed constructions are particularly useful in large-scale eigensolver workflows, target-region computations, and hardware-accelerated implementations.

In certain embodiments, the operator is not purely local. With continued reference to FIG. 2, the nonlocal term 214 may be included in the assembled operator 220 to represent coupling relationships that are not limited to pointwise multiplication by the local potential term 212. In some embodiments, the nonlocal term 214 is represented by or associated with the Toeplitz kernel 216. In certain embodiments, the Toeplitz kernel 216 is used to realize a structured matrix or integral-kernel contribution in which repeated patterns or diagonal-constant structure permit efficient transform-based evaluation. In some embodiments, the low-rank component 218 represents a correction, approximation, residual term, compression term, or reduced-order component associated with the nonlocal term 214 or the assembled operator 220 more generally. Thus, in certain embodiments, the operator construction module 106 produces an assembled operator 220 that includes a local kinetic term, a local transformed-potential term, and one or more supplemental nonlocal or structured terms that preserve or approximate the desired spectral behavior while enabling efficient numerical realization.

In certain embodiments, the disclosed subject matter supports truncated and finite-dimensional operator realizations. For example, the operator construction module 106 may construct the assembled operator 220 as a finite matrix on a computational grid or basis, rather than as an infinite-dimensional symbolic operator. In some embodiments, the finite matrix is sparse, banded, symmetric, Hermitian, Toeplitz-enhanced, low-rank-corrected, or otherwise structured. In some embodiments, the local kinetic term 210 is discretized using finite differences, finite elements, spectral basis functions, or other numerical schemes, while the local potential term 212 is represented through diagonal, near-diagonal, basis-weighted, or transformed entries. In certain embodiments, the nonlocal term 214 is represented by a dense matrix, a structured matrix, a Toeplitz matrix, a low-rank matrix, a compressed operator representation, or a matrix-free transform routine. In this way, the operator construction disclosed herein expressly supports both continuum notation and the practical finite-dimensional forms used in computation, validation, and codec preparation.

In certain embodiments, the disclosed operator construction also supports an effective-Hamiltonian or recognition-operator bridge. That is, in some embodiments, the operator construction module 106 may receive as input a discrete recognition-evolution relation, an effective cost-propagation law, or another recognition-operator-based specification, and may generate from that input an effective operator suitable for spectral extraction. In some embodiments, this effective operator is local and Schrödinger-like. In other embodiments, the effective operator is only approximately local or only approximately quadratic in a small-strain regime. In still other embodiments, the effective operator is expressed in a mixed symbolic-computational form. By preserving these variants, the present disclosure supports later claim strategies directed not only to the exact self-adjoint operator realization, but also to effective-operator and recognition-derived spectral constructions that produce equivalent or substantially equivalent computational results in practice.

In certain embodiments, the operator construction is performed for target spectra associated with the Riemann zeta function. In other embodiments, the operator construction module 106 is configured to generate generalized target-spectrum operators, including operators adapted for Dirichlet L-functions, character-weighted spectra, Maass-form-related spectra, automorphic spectra, or other number-theoretic or mathematical spectral targets. In some embodiments, this generalization is accomplished by modifying the transformed potential output 208, by introducing a weighting factor into the local potential term 212, by altering one or more nonlocal terms, by changing one or more domain or boundary realizations, by changing the interpretation of the ordered spectral output, or by a combination of the foregoing. In certain embodiments, such generalized target-spectrum operators remain within the same overall architecture because they are generated by the operator construction module 106 and passed through the same or similar discretization, eigensolver, verification, and codec infrastructure.

Accordingly, in certain embodiments, the operator construction disclosed herein comprises a family of recognition-derived spectral constructions rather than a single isolated symbolic formula. That family includes exact local differential operators, equivalent symbolic operators, shifted and weighted operators, local-plus-nonlocal operators, truncated and finite-dimensional operators, effective operators derived from recognition evolution structures, and generalized target-spectrum operators. All such embodiments may be generated, assembled, or otherwise realized through the operator construction module 106 and represented through the assembled operator 220 for subsequent processing by the discretization module 108, the eigensolver module 110, the verification module 112, the codec module 114, and one or more hardware and deployment embodiments 700.

In certain embodiments, the disclosed operator constructions are realized on selected domains and with selected boundary conditions such that the resulting operator possesses desired spectral and computational properties, including in some embodiments self-adjointness, real spectrum, discrete spectrum, numerical stability, and compatibility with solver workflows. With reference to FIG. 3, the domain and boundary embodiment 300 includes, in certain embodiments, a half-line domain 302, a full-line domain 304, a truncated computational domain 306, a Dirichlet boundary condition 308, a Neumann boundary condition 310, a Robin boundary condition 312, a mixed boundary condition 314, a Friedrichs-extension embodiment 316, and a self-adjoint domain specification 318. These embodiments are illustrative of a broader family of analytical and computational realizations in which a recognition-derived operator may be implemented on one or more function spaces, matrix spaces, basis spaces, finite computational intervals, or transformed coordinate spaces.

In certain embodiments, the operator is realized on the half-line domain 302. In one representative half-line embodiment, the transformed coordinate x is restricted to a positive or nonnegative interval, such as x greater than or equal to 0, and the operator is defined on functions satisfying one or more regularity, integrability, and boundary conditions at the origin and at infinity or an effective truncation point. In some embodiments, the half-line domain 302 is useful where the transformed variable is interpreted in a ratio-based or positive-coordinate framework and where symmetry, truncation, or computational efficiency favors a one-sided realization. In certain embodiments, the half-line domain 302 is paired with a selected boundary condition at the origin and with decay, integrability, or truncation requirements at large x. In some embodiments, the half-line realization provides a convenient framework for obtaining a confining operator with ordered spectral values while preserving compatibility with discretization on a one-sided logarithmic grid.

In certain embodiments, the operator is realized on the full-line domain 304. In one representative full-line embodiment, the transformed coordinate x ranges over all real values, and the operator is defined on functions satisfying selected integrability, smoothness, decay, symmetry, or equivalent realization requirements. In some embodiments, the full-line domain 304 is useful because the transformed potential V_RP(x)=cosh(x)−1 is even in x and naturally supports symmetric analysis across positive and negative coordinates. In certain embodiments, the full-line domain 304 may be advantageous for parity-based analysis, symmetric basis expansions, or computational schemes that exploit the evenness of the transformed potential. In some embodiments, the full-line realization is implemented directly, and in other embodiments the full-line realization is reduced, projected, or symmetry-decomposed into an equivalent half-line or parity-restricted realization. Thus, the disclosed subject matter expressly supports both one-sided and two-sided coordinate-domain constructions.

In certain embodiments, the operator is realized on a truncated computational domain 306. A truncated computational domain 306 may comprise a finite interval, a finite window, a bounded transformed-coordinate region, a finite basis span, a finite matrix index range, or another bounded representation selected for numerical computation. In some embodiments, truncation is used to convert an otherwise unbounded analytical domain into a finite-dimensional computational problem. In some embodiments, the truncation boundary is chosen to preserve the relevant spectral content within a target error tolerance, a target spectral window, or a target height region. In certain embodiments, the truncated computational domain 306 is selected adaptively based on solver tolerance, target index, target ordinate range, asymptotic growth of the transformed potential, or hardware memory constraints. In some embodiments, the truncated computational domain 306 is used only for finite computation and does not alter the conceptual continuum operator from which the numerical realization is derived.

In certain embodiments, the operator realization is associated with a Dirichlet boundary condition 308. In a representative Dirichlet embodiment, the realized function, vector, or basis representation is constrained to vanish at one or more boundaries, including at the origin, at a truncation boundary, or at both. In some embodiments, the Dirichlet boundary condition 308 provides a convenient and computationally stable realization of the operator on the half-line domain 302 or the truncated computational domain 306. In certain embodiments, the Dirichlet condition is used because it is compatible with a lower-bounded confining operator structure and yields a well-defined discrete matrix realization under standard discretization schemes. In some embodiments, one or more basis functions are selected so that the Dirichlet condition is built into the representation. In other embodiments, the condition is imposed algebraically, variationally, or through elimination of boundary degrees of freedom.

In certain embodiments, the operator realization is associated with a Neumann boundary condition 310. In a representative Neumann embodiment, the derivative, flux, or equivalent gradient-related quantity is constrained at one or more boundaries. In some embodiments, the Neumann boundary condition 310 is useful where a symmetry relation, parity relation, reflective condition, or conserved-flow interpretation favors constraining a derivative quantity rather than a function value. In certain embodiments, a Neumann condition is imposed at the origin in a parity-adapted half-line realization corresponding to an even full-line extension. In other embodiments, the Neumann condition is imposed at a truncation boundary selected to minimize spurious reflection, numerical bias, or edge-induced spectral distortion. In some embodiments, the Neumann realization is advantageous for basis methods, weak formulations, or finite-element schemes.

In certain embodiments, the operator realization is associated with a Robin boundary condition 312. In a representative Robin embodiment, a linear relation between a boundary value and a boundary derivative is imposed, optionally with one or more coefficients or scaling terms selected for the realization. In some embodiments, the Robin boundary condition 312 provides a flexible intermediate condition between Dirichlet and Neumann behavior and may be used to model effective boundary physics, asymptotic matching, absorbing boundaries, regularized truncation, or generalized self-adjoint boundary families. In certain embodiments, the Robin condition is particularly useful where the operator is realized on a finite interval but is intended to approximate an unbounded-domain operator with controlled boundary artifacts. In some embodiments, the coefficients of the Robin condition are selected analytically, asymptotically, numerically, or adaptively.

In certain embodiments, the operator realization is associated with a mixed boundary condition 314. A mixed boundary condition 314 may include different conditions at different ends of the domain, different conditions on different parity sectors, different conditions in different basis subspaces, or a combination of one or more Dirichlet, Neumann, Robin, variational, absorbing, symmetry-based, or computationally equivalent conditions. In some embodiments, mixed boundary conditions are useful where one boundary is treated as a regularity boundary and another boundary is treated as a truncation boundary. In some embodiments, a mixed boundary condition 314 is chosen to reduce spurious spectral pollution, improve conditioning, preserve parity structure, or better approximate the asymptotic behavior of the continuum problem in a finite numerical realization. In certain embodiments, mixed conditions may also be used in generalized target-spectrum embodiments or in local-plus-nonlocal operator realizations.

In certain embodiments, the operator is realized through a Friedrichs-extension embodiment 316. In such embodiments, the operator is associated with a lower-bounded quadratic form, energy form, cost-derived form, or equivalent variational structure from which a self-adjoint realization is obtained. In some embodiments, the Friedrichs-extension embodiment 316 is useful because the transformed potential is non-negative, confining, and compatible with a lower-bounded operator construction. In certain embodiments, the extension-based realization provides a canonical or preferred self-adjoint form for the local operator and, in some embodiments, for broader operator families including selected nonlocal or corrected embodiments. In some embodiments, the Friedrichs-extension embodiment 316 is used to define the continuum operator, while the discretization module 108 constructs a corresponding finite-dimensional matrix realization for computation. In other embodiments, the Friedrichs-extension embodiment 316 serves as an analytical justification for the spectral properties of a family of computational approximations.

In certain embodiments, the self-adjoint domain specification 318 comprises a selected combination of domain choice, boundary choice, coefficient structure, regularity condition, decay or truncation condition, symmetry treatment, and operator form sufficient to define a self-adjoint realization or a realization having the computationally relevant properties of such a form. In some embodiments, self-adjointness is important because it supports real spectral values, ordered eigenvalue extraction, stable orthogonal or orthonormal mode structures, and applicability of solver workflows designed for symmetric or Hermitian operators. In certain embodiments, the self-adjoint domain specification 318 is explicitly analytical. In other embodiments, it is embodied through a symmetric finite matrix, a Hermitian matrix, a variational discretization, a boundary-enforced sparse matrix, or another finite-dimensional representation corresponding to an underlying self-adjoint or equivalent continuum form. In some embodiments, this permits the disclosed spectral workflows to move seamlessly between continuum theory and numerical implementation.

In certain embodiments, the disclosed subject matter also supports matrix self-adjoint realizations even where the continuum operator is not manipulated directly during computation. For example, the discretization module 108 may construct a symmetric or Hermitian finite matrix corresponding to the assembled operator 220 on the selected domain and under the selected boundary conditions. In some embodiments, the local kinetic term 210 is discretized into a banded or sparse symmetric matrix, the local potential term 212 is represented as a diagonal or near-diagonal matrix contribution, and the nonlocal term 214 is represented as a structured, Toeplitz, low-rank, or transform-compatible matrix contribution. In some embodiments, the resulting matrix realization is treated as the operative self-adjoint object for numerical eigensolution, regardless of whether the continuum operator is also separately analyzed. This is particularly useful in hardware implementations and large-scale spectral computations where the solver acts directly on matrix or matrix-free operator evaluations.

In certain embodiments, domain and boundary choices may vary according to target use. For example, a half-line domain 302 with a Dirichlet boundary condition 308 may be selected for a primary local zeta-target embodiment. A full-line domain 304 with parity-adapted Neumann or Dirichlet behavior may be selected for a symmetric full-potential study. A truncated computational domain 306 with a Robin boundary condition 312 may be selected for high-index numerical extraction. A mixed boundary condition 314 may be selected for generalized target-spectrum embodiments, local-plus-nonlocal operators, or reduced-order matrix realizations. Thus, the present disclosure intentionally preserves a broad family of domain and boundary choices so that later claim amendment or prosecution argument is not limited to a single origin condition, interval structure, or extension theory.

Accordingly, in certain embodiments, the disclosed subject matter provides a domain and realization architecture in which the operator may be implemented on the half-line domain 302, the full-line domain 304, or the truncated computational domain 306, and may be paired with the Dirichlet boundary condition 308, the Neumann boundary condition 310, the Robin boundary condition 312, the mixed boundary condition 314, the Friedrichs-extension embodiment 316, and the self-adjoint domain specification 318, individually or in combination, to produce analytical and computational operator realizations suitable for subsequent spectral extraction by the numerical solver and acceleration workflow 400, validation by the verification and spectral correspondence workflow 500, codec use in the prime-spectral codec system 600, and implementation in the hardware and deployment embodiments 700.

In certain embodiments, the operator constructions and realizations described herein are selected and implemented so as to produce ordered spectral values suitable for number-theoretic computation, comparison, validation, indexing, and compression. With reference to FIG. 2, FIG. 3, and FIG. 5, the assembled operator 220, when realized on a selected domain and under a selected boundary framework such as the self-adjoint domain specification 318, may yield a spectrum that is real, ordered, discrete in whole or in relevant part, and computationally extractable through the workflows described herein. In certain embodiments, the transformed potential output 208, together with the selected realization of the kinetic term 210, provides an operator environment in which the resulting spectral values may be interpreted as spectral ordinates, candidate zeta-zero-associated values, generalized target-spectrum values, comparison values, or spectrum-domain coding values. In some embodiments, the spectral values are produced directly by eigensolution. In other embodiments, the spectral values are produced by approximation, refinement, matrix realization, basis projection, shifted computation, or lookup from a previously generated spectral database.

In certain embodiments, the disclosed operator has structural properties that support a real spectrum. For example, where the operator is realized under the self-adjoint domain specification 318 or an equivalent symmetric or Hermitian matrix specification, the computed spectral values may be constrained to lie on the real axis or to behave as real ordered spectral quantities within the operative numerical model. In some embodiments, this property is important because the intended target quantities, including candidate ordinates corresponding to non-trivial zeta zeros, are treated as ordered real values. In certain embodiments, real-spectrum behavior also improves computational stability, ordering, comparison logic, interval selection, and downstream indexing in the prime-spectral codec system 600. In some embodiments, real-spectrum behavior is established analytically. In other embodiments, it is enforced or preserved numerically through symmetric discretization, self-adjoint boundary selection, Hermitian matrix construction, or equivalent implementation choices.

In certain embodiments, the disclosed operator has structural properties that support a discrete spectrum, or at least a discrete spectral subset in a selected computational regime. Because the transformed potential output 208 may be confining, non-negative, and increasing away from its minimum, and because the operator may be realized on a bounded or effectively bounded computational region through the truncated computational domain 306, the resulting spectral values may be obtained as an ordered sequence suitable for indexed computation. In some embodiments, the spectrum is discrete in the underlying analytical realization. In other embodiments, the operationally relevant spectrum is discrete because a finite-dimensional or truncated matrix representation is used. In some embodiments, this discreteness is useful for assigning indices, performing spectral matching, generating lookup tables, coding prime-indexed values, or performing batch extraction of ordered ordinates. In certain embodiments, ordered discreteness is preserved even where nonlocal terms or corrective structures are included, provided the resulting computational realization maintains the intended structured spectral behavior.

In certain embodiments, the spectral values produced by the assembled operator 220 are associated with target spectra through the verification and spectral correspondence workflow 500. With reference to FIG. 5, the computed spectrum input 502 may comprise spectral values obtained from a local operator realization, a local-plus-nonlocal operator realization, a finite-dimensional realization, an effective operator realization, or another disclosed operator embodiment. The reference spectrum input 504 may comprise a zeta-zero reference dataset, an L-function reference dataset, a Maass-spectrum dataset, an automorphic-spectrum dataset, a synthetic validation dataset, a statistical target, or another comparison source. The alignment engine 506 may align the computed spectrum input 502 with the reference spectrum input 504 by index, by order, by spectral window, by target band, by monotonic ordering, by interpolation, by local neighborhood selection, or by other matching logic. In some embodiments, this alignment enables direct comparison of a computed ordinate 516 with a reference ordinate 518 for a selected spectral index 514. In other embodiments, the alignment supports batch validation, interval validation, or distributional comparison rather than one-to-one matching.

In certain embodiments, target association is performed with respect to spectral values corresponding to or associated with non-trivial zeros of the Riemann zeta function. In such embodiments, the computed ordinate 516 may be treated as a candidate value corresponding to a zeta-zero ordinate at the same or corresponding spectral index 514, and the reference ordinate 518 may be drawn from a reference zero table or other zeta-zero data source. In some embodiments, the error engine 508 computes absolute error, relative error, normalized error, residual error, or another comparison quantity. In certain embodiments, the count-matching module 520 is additionally or alternatively used to compare the number of computed spectral values in a selected interval to an expected count derived from a reference table, asymptotic count expression, or another target criterion. In some embodiments, the certification output 522 records whether the computed spectral values satisfy one or more thresholds for numerical correspondence. In this way, the disclosed framework supports direct zeta-target comparison while remaining broad enough to encompass related comparison modes.

In certain embodiments, the target association is not limited to one-to-one ordinate matching. In some embodiments, the spacing-statistics engine 510 analyzes local or transformed spacing distributions of the computed spectrum input 502. In certain embodiments, this may include nearest-neighbor spacings, normalized spacings, higher-order gap statistics, delta statistics, or other local spectral measures. In some embodiments, the rigidity engine 512 analyzes longer-range behavior, including spectral rigidity, interval-count variance, number variance, or related consistency measures. These engines may operate with or without explicit one-to-one mapping to a reference ordinate list. In some embodiments, target association is achieved by demonstrating that the statistical structure of the computed spectral values is consistent with that of a reference spectrum or target spectral ensemble. In certain embodiments, such statistical association is useful where exact index alignment is computationally inconvenient, where target windows are large, where only partial reference data are available, or where the spectral values are used as surrogates or computational models rather than exact table replacements.

In certain embodiments, the disclosed subject matter supports generalized target association beyond the Riemann zeta function. For example, the reference spectrum input 504 may correspond to zeros of one or more Dirichlet L-functions, spectra associated with one or more Maass forms, automorphic spectra, or other mathematical or number-theoretic target structures. In some embodiments, the assembled operator 220 is correspondingly modified through weighting, boundary selection, operator correction, target-specific construction, or another adaptation. In other embodiments, the operator remains unchanged but is used as a surrogate or approximate target-spectrum generator for comparative or modeling purposes. In certain embodiments, the target selector associated with generalized spectral-target embodiments may identify which target family is active, and the alignment engine 506, error engine 508, spacing-statistics engine 510, rigidity engine 512, and count-matching module 520 may be configured accordingly. Thus, the present disclosure expressly preserves support for target association that extends beyond a single zeta-specific use case.

In certain embodiments, the spectral values produced by the assembled operator 220 are used not only for validation, but also for storage, indexing, retrieval, and downstream computation. For example, once a sequence of spectral ordinates has been computed and optionally validated, those values may be stored in a spectral table, spectral cache, lookup structure, or indexed database. In some embodiments, the spectral lookup 608 in the prime-spectral codec system 600 accesses such stored spectral values by prime index, spectral index, interval, or target window. In some embodiments, the computed spectrum input 502 and certification output 522 are stored together so that later workflows can distinguish between validated spectral values, estimated spectral values, interpolated spectral values, and target-window approximations, and so that a downstream process can determine whether a retrieved spectral value satisfies a selected acceptance condition. In certain embodiments, the spectral index 514 becomes a reusable identifier for downstream workflows including compression, decompression, keying, randomization, modeling, or API-based access. In this sense, the disclosed spectral properties are important not only mathematically, but also architecturally, because they support reliable downstream use of the computed values as structured data objects.

In certain embodiments, different realizations of the operator may be selected according to the desired spectral-property profile. For example, a strictly local self-adjoint realization on the half-line domain 302 may be selected where direct ordered real spectral values are the primary objective. A full-line domain 304 with parity-aware decomposition may be selected where symmetry analysis is desired. A truncated computational domain 306 with a selected boundary condition may be selected where high-throughput numerical extraction is prioritized. A local-plus-nonlocal assembled operator 220 may be selected where richer spectral modeling or transform-compatible acceleration is desired. A generalized target-spectrum operator may be selected where the intended target association is not limited to zeta-zero data. In all such embodiments, the present disclosure preserves flexibility in how spectral properties are obtained while maintaining continuity with the overall system architecture shown in FIG. 1 through FIG. 7.

Accordingly, in certain embodiments, the disclosed subject matter provides a spectral architecture in which the assembled operator 220, when realized on a selected domain and under selected boundary conditions, yields ordered spectral values having properties suitable for association with one or more target spectra. Such association may be direct, statistical, approximate, surrogate-based, or target-family-dependent, and may be implemented through the computed spectrum input 502, the reference spectrum input 504, the alignment engine 506, the error engine 508, the spacing-statistics engine 510, the rigidity engine 512, the spectral index 514, the computed ordinate 516, the reference ordinate 518, the count-matching module 520, and the certification output 522. These spectral values may then be passed to the numerical solver and acceleration workflow 400 for continued extraction, to the prime-spectral codec system 600 for mapping and compression, and to the hardware and deployment embodiments 700 for practical implementation and use.

In certain embodiments, the disclosed subject matter provides numerical discretization and solver workflows configured to convert the assembled operator 220 into a finite computational representation and to extract ordered spectral values therefrom with useful precision, throughput, and scalability. With reference to FIG. 1 and FIG. 4, the discretization module 108 and the eigensolver module 110 may cooperate within the numerical solver and acceleration workflow 400 to generate a grid or basis representation, assemble a corresponding matrix or matrix-free operator action, execute one or more eigensolver procedures, refine one or more resulting spectral values, and output ordered spectral ordinates to the spectral output buffer 422 for downstream verification, storage, lookup, or codec use. In some embodiments, these workflows are implemented for a local self-adjoint operator realization. In other embodiments, the same workflows are adapted to local-plus-nonlocal operators, effective operators, truncated operators, shifted operators, or generalized target-spectrum operators.

In certain embodiments, the numerical solver and acceleration workflow 400 begins with the grid construction stage 402. The grid construction stage 402 may generate a logarithmic grid, an adaptive grid, a uniform grid, a nonuniform grid, a shifted grid, a target-window grid, a transformed-coordinate grid, or another computational sampling structure. In some embodiments, a logarithmic grid is especially useful where the transformed coordinate x=ln(X) is used directly and where the operator is naturally expressed in that coordinate. In certain embodiments, the grid spacing is selected to balance spectral accuracy, matrix conditioning, truncation effects, and computational cost. In some embodiments, the grid is denser in regions where the transformed potential output 208 has greater curvature or where the corresponding eigenfunctions are expected to vary more rapidly. In other embodiments, a basis-oriented construction may be used in place of or together with an explicit point grid.

In certain embodiments, the discretization stage 404 constructs a finite representation of the assembled operator 220. In one representative embodiment, the kinetic term 210 is discretized by a finite-difference stencil, such as a central-difference stencil, to yield a tridiagonal, banded, or sparse matrix contribution. In another embodiment, the kinetic term 210 is represented using finite elements, basis functions, weak forms, spectral collocation, Galerkin projection, or another discretization method. In some embodiments, the local potential term 212 is discretized as a diagonal or near-diagonal matrix using values of the transformed potential output 208 evaluated at grid points, quadrature points, basis nodes, or transformed coordinates. In certain embodiments, the nonlocal term 214 is represented by a dense matrix, a structured matrix, a Toeplitz-compatible matrix, a low-rank update, an integral-kernel evaluation routine, or a matrix-free transform-compatible operator action. Thus, in some embodiments, the discretization stage 404 yields a finite matrix H that is real and symmetric, Hermitian, sparse, structured, or a combination thereof.

In certain embodiments, the numerical workflow uses an initial vector stage 406 to prepare one or more starting vectors for eigensolution. In some embodiments, the starting vector is random, pseudorandom, structured, deterministic, basis-aligned, parity-selected, window-selected, or otherwise adapted to the target computation. In certain embodiments, multiple starting vectors are used where block methods are employed. In some embodiments, the choice of initial vector is selected to accelerate convergence for low-order spectral values, target-window spectral values, or parity-specific subspaces. In certain embodiments, initial-vector preparation may also include normalization, orthogonalization, projection onto a selected basis, or filtering relative to a selected shift or target interval.

In certain embodiments, the eigensolver module 110 constructs a Krylov subspace at the Krylov subspace stage 408. The Krylov subspace stage 408 may form a sequence of vectors generated by repeated action of the finite operator representation on one or more starting vectors. In some embodiments, this subspace is used in a Lanczos-type workflow suitable for symmetric or Hermitian operator realizations. In certain embodiments, the Lanczos recursion stage 410 executes a three-term recurrence or another reduced recurrence relation to build a tridiagonal or block-tridiagonal reduced representation whose Ritz values approximate the desired spectral ordinates. In some embodiments, this workflow is particularly well suited to the assembled operator 220 where the discretized representation is sparse, structured, or transform-accelerable. In certain embodiments, block Lanczos variants are employed to extract multiple spectral values concurrently, reduce startup overhead, or exploit accelerator parallelism.

In certain embodiments, the reorthogonalization stage 412 is used to control numerical loss of orthogonality in the generated basis vectors. In some embodiments, selective reorthogonalization is performed after a selected number of Lanczos steps, after detection of spectral clustering, after a threshold loss of orthogonality, or according to another scheduling rule. In certain embodiments, reorthogonalization reduces ghost eigenvalues, repeated Ritz-value contamination, or instability in high-iteration workflows. In some embodiments, full reorthogonalization, partial reorthogonalization, restart-based stabilization, or other numerical hygiene procedures may be employed depending on the selected implementation.

In certain embodiments, approximate spectral values are extracted at the Ritz extraction stage 414. In some embodiments, the Ritz extraction stage 414 computes eigenvalues of a reduced tridiagonal, banded, or block-reduced matrix obtained from the Krylov-subspace process. In certain embodiments, the resulting Ritz values are treated as approximate spectral ordinates and may be sorted, indexed, filtered, windowed, parity-resolved, or compared against target ranges before further refinement. In some embodiments, the Ritz extraction stage 414 also computes Ritz vectors or related approximate eigenvectors, residual norms, subspace projections, or convergence indicators. In certain embodiments, the output of the Ritz extraction stage 414 is passed to the refinement stage 416 to improve one or more spectral values.

In certain embodiments, the refinement stage 416 improves approximate spectral values through one or more iterative or corrective procedures. In some embodiments, refinement comprises Rayleigh-quotient iteration, inverse iteration, residual minimization, shift-based correction, localized re-solve, target-window correction, or another eigenvalue-improvement workflow. In certain embodiments, the refinement stage 416 is configured to reduce relative error below a selected threshold. In some embodiments, refinement is applied to all extracted spectral values. In other embodiments, refinement is applied only to selected spectral values, such as values intended for certification, database storage, spectral correspondence studies, or codec lookup generation. In certain embodiments, the refined values are written to the spectral output buffer 422 together with one or more convergence indicators, residual values, validation flags, or metadata fields.

In certain embodiments, the numerical solver and acceleration workflow 400 employs a Toeplitz/FFT acceleration stage 418. In some embodiments, the Toeplitz/FFT acceleration stage 418 is used where the nonlocal term 214, the Toeplitz kernel 216, or another structured matrix contribution permits efficient transform-domain computation of matrix-vector products. In certain embodiments, a matrix-vector product that would otherwise require O(N\hat{ }2) work may be accelerated by FFT-based convolution, spectral-domain multiplication, precomputed coefficient access, or related transform-assisted processing. In some embodiments, this acceleration is especially useful in repeated Krylov-subspace iterations, block eigensolver workflows, or batch computations in which the same structured operator action is applied many times. In certain embodiments, transform coefficients, kernel values, or auxiliary arrays are stored in local memory, shared memory, cache, accelerator memory, or other fast-access structures to reduce repeated overhead.

In certain embodiments, a convergence test 420 is used to determine whether a target eigensolution quality has been reached. In some embodiments, the convergence test 420 is based on residual norm, relative change in spectral values, orthogonality preservation, interval stability, comparison to a reference threshold, count stability within a selected spectral window, or another stopping criterion. In certain embodiments, the convergence test 420 is configured differently for exploratory runs, certified runs, batch extraction, high-throughput approximate extraction, or target-window computations. In some embodiments, once convergence is satisfied, one or more spectral values are committed to the spectral output buffer 422. In other embodiments, the workflow returns to an earlier stage to enlarge the Krylov subspace, adjust a shift, expand a domain, change a grid density, or apply additional refinement.

In certain embodiments, the spectral output buffer 422 stores spectral ordinates, indices, residuals, certification metadata, parity information, target-window identifiers, shift parameters, or related information needed for later processing. In some embodiments, values stored in the spectral output buffer 422 are passed directly to the verification module 112 for comparison against a reference spectrum input 504. In some embodiments, values stored in the spectral output buffer 422 are loaded into a spectral table or database for later access by the spectral lookup 608 of the prime-spectral codec system 600. In certain embodiments, values stored in the spectral output buffer 422 are transmitted through the output interface 118 or the accelerator interface 116 to other processes, devices, or users.

In certain embodiments, the disclosed numerical workflows are not limited to one eigensolver family. Although a Krylov/Lanczos-based arrangement is representative and advantageous in many embodiments, the eigensolver module 110 may additionally or alternatively employ Arnoldi-type methods, Jacobi-Davidson methods, shift-invert schemes, contour-based eigensolvers, filtered subspace methods, inverse iteration schemes, direct diagonalization in reduced-size problems, or quantum phase-estimation-related workflows in suitable hardware embodiments. In some embodiments, the discretization stage 404 and the convergence test 420 are adapted accordingly. In certain embodiments, this flexibility is useful for preserving support across a broad claim set and for matching solver strategy to domain choice, operator structure, hardware availability, and target-spectrum requirements.

Accordingly, in certain embodiments, the numerical solver and acceleration workflow 400 provides an integrated path from the assembled operator 220 to a finite computational realization, from that realization to approximate spectral values through the grid construction stage 402, the discretization stage 404, the initial vector stage 406, the Krylov subspace stage 408, the Lanczos recursion stage 410, the reorthogonalization stage 412, the Ritz extraction stage 414, and the refinement stage 416, and from there to transform-assisted processing through the Toeplitz/FFT acceleration stage 418, convergence control through the convergence test 420, and ordered result storage in the spectral output buffer 422. These outputs may then be used for target association within the verification and spectral correspondence workflow 500, for lookup and transform operations within the prime-spectral codec system 600, and for execution on one or more hardware and deployment embodiments 700.

In certain embodiments, the disclosed subject matter further provides nonlocal acceleration and matrix-structure exploitation techniques configured to improve computational efficiency, memory efficiency, throughput, and scalability in connection with the assembled operator 220 and the numerical solver and acceleration workflow 400. With reference to FIG. 2, FIG. 4, and FIG. 7, such techniques may be used where the assembled operator 220 includes, or is usefully represented by, the nonlocal term 214, the Toeplitz kernel 216, the low-rank component 218, the Toeplitz/FFT acceleration stage 418, the shared memory region 708, the FFT engine 710, or the batch-eigensolver architecture 712. In some embodiments, these techniques are used to accelerate repeated operator applications during Krylov-subspace generation, block eigensolver operation, refinement, verification, codec-table generation, or batch spectral extraction. In other embodiments, these techniques are used to reduce storage requirements, improve data reuse, enable matrix-free processing, or permit larger problem sizes on a selected hardware platform.

In certain embodiments, the assembled operator 220 is not treated as a fully dense unstructured matrix. Rather, one or more components of the assembled operator 220 may possess structure that can be exploited computationally. In some embodiments, the local kinetic term 210 is sparse or banded after discretization. In some embodiments, the local potential term 212 is diagonal or near-diagonal. In some embodiments, the nonlocal term 214 is represented by a Toeplitz, block-Toeplitz, convolutional, translation-invariant, approximately translation-invariant, low-rank, or otherwise structured component. In certain embodiments, one or more of these structures permit matrix-vector products or equivalent operator applications to be computed more efficiently than would be possible with a general dense matrix representation. In some embodiments, the operator construction module 106 and the discretization module 108 are configured to preserve, expose, or encode this structure explicitly so that the eigensolver module 110 can exploit it during numerical solution.

In certain embodiments, the Toeplitz kernel 216 is used to represent all or part of the nonlocal term 214. A Toeplitz kernel 216 may comprise a matrix or operator component having entries that are constant along one or more diagonals, or otherwise admit a transform-compatible convolutional representation. In some embodiments, the Toeplitz kernel 216 arises from an integral-kernel formulation, a discretized convolution relation, a translationally regular nonlocal coupling, or an equivalent structured realization. In certain embodiments, the Toeplitz kernel 216 is not required to represent the entirety of the assembled operator 220, but instead may represent one structured component combined with sparse local terms or low-rank corrections. In some embodiments, this hybrid structure permits the operator to retain rich spectral behavior while still supporting efficient repeated application during iterative eigensolution.

In certain embodiments, the Toeplitz/FFT acceleration stage 418 is configured to exploit the Toeplitz kernel 216 through transform-based computation. In some embodiments, a vector acted on by the structured nonlocal portion of the operator is transformed using a forward transform, multiplied by a spectral-domain kernel representation, and then returned to the original domain using an inverse transform. In certain embodiments, this operation is performed using one or more FFT procedures, although other fast transforms, convolution engines, polynomial transforms, block transforms, or equivalent acceleration techniques may also be employed. In some embodiments, this transform-based approach reduces the cost of repeated matrix-vector products relative to naive dense multiplication. In certain embodiments, the Toeplitz/FFT acceleration stage 418 is especially beneficial in Krylov-subspace workflows because many repeated operator applications are required to generate subspace vectors and refine target spectral values.

In certain embodiments, the low-rank component 218 is used to represent a correction, update, approximation, or compressed residual associated with the nonlocal term 214 or with the assembled operator 220 more generally. In some embodiments, the low-rank component 218 captures a slowly varying, structured, or dominant subspace contribution that can be stored and applied more economically than a full dense correction. In certain embodiments, the low-rank component 218 is combined with the Toeplitz kernel 216 to form a hybrid structured operator. In some embodiments, one or more Sherman-Morrison-type, Woodbury-type, subspace-projected, factored, or compressed update procedures may be used to apply or invert such low-rank structures efficiently. In certain embodiments, the low-rank component 218 is particularly useful where the nonlocal term 214 is well approximated by a dominant structured kernel plus a lower-dimensional correction.

In certain embodiments, the disclosed subject matter supports matrix-free operator application. In some embodiments, rather than explicitly assembling and storing every entry of the assembled operator 220, the operator is represented procedurally through separate routines for the kinetic term 210, the local potential term 212, the nonlocal term 214, and any structured transforms associated with the Toeplitz kernel 216 or the low-rank component 218. In certain embodiments, a matrix-vector product is then computed by sequentially applying these routines to an input vector. In some embodiments, matrix-free operation reduces storage demands and allows larger computational domains, finer grids, higher target indices, or more aggressive batching. In certain embodiments, matrix-free processing is especially advantageous on GPU, FPGA, ASIC, and distributed platforms where memory bandwidth or memory footprint may be more limiting than arithmetic throughput.

In certain embodiments, the shared memory region 708 is used to cache vector segments, kernel coefficients, transform coefficients, stencil values, basis data, or intermediate products associated with the Toeplitz/FFT acceleration stage 418 or with repeated local operator application. In some embodiments, this caching reduces repeated accesses to slower memory and improves throughput for batched or iterative workflows. In certain embodiments, the FFT engine 710 provides a dedicated or semi-dedicated computational path for forward and inverse transforms used in structured operator application. In some embodiments, the FFT engine 710 is implemented in software, firmware, programmable logic, fixed-function logic, or a hybrid thereof. In certain embodiments, the batch-eigensolver architecture 712 is configured to process multiple spectral targets, multiple starting vectors, multiple blocks, or multiple problem instances concurrently, thereby amortizing setup costs associated with structured operator application, transform planning, coefficient loading, or basis preparation.

In certain embodiments, the structured acceleration techniques disclosed herein are used not only during eigensolution, but also during refinement, validation, spectral-table generation, and codec preparation. For example, where a large spectral table is to be generated for later use by the spectral lookup 608 of the prime-spectral codec system 600, repeated use of structured operator application can materially reduce total runtime and energy consumption. In some embodiments, structured acceleration is also useful for target-window computation in which multiple nearby spectral ordinates are extracted around a selected target region. In certain embodiments, the same structured representations may also support repeated verification calculations, interval-count computations, spacing-distribution generation, or sensitivity studies across related operator embodiments. Thus, nonlocal acceleration and matrix-structure exploitation are not merely optional solver optimizations, but form part of the broader computational architecture of the disclosed system.

In certain embodiments, different matrix-structure strategies may be selected according to the operative hardware platform. For example, on a GPU server 702, the disclosed workflows may exploit the shared memory region 708, parallel reduction patterns, batched FFT execution, and vectorized sparse-local plus structured-nonlocal kernels. On an FPGA accelerator 704, the Toeplitz kernel 216, low-rank component 218, and FFT engine 710 may be implemented through pipelined dataflow, fixed-point or floating-point arithmetic, high-bandwidth memory, or custom transform logic. On an ASIC implementation 706, the structured operator may be hardwired or semi-configurable for repeated high-throughput spectral extraction or codec support. In distributed embodiments associated with the cloud or distributed-computing environment 724, different operator segments, transform stages, or spectral windows may be partitioned across nodes or accelerator pools. In this way, the disclosed matrix-structure exploitation is expressly compatible with multiple hardware embodiments rather than being confined to one software-only realization.

In certain embodiments, the disclosed subject matter also supports adaptive selection of structured representations. In some embodiments, the operator construction module 106 or the discretization module 108 evaluates whether a given operator embodiment is best represented as sparse plus diagonal, sparse plus Toeplitz, sparse plus low-rank, block-structured, matrix-free, or fully explicit. In certain embodiments, such selection is based on domain size, target index, desired precision, available hardware resources, memory constraints, solver type, convergence behavior, or the relative strength of nonlocal coupling. In some embodiments, one representation is used during initial exploration and another is used during certified extraction or final refinement. This adaptive selection further broadens the practical support of the specification and reduces the risk that later claim coverage would be confined to a single rigid numerical architecture.

Accordingly, in certain embodiments, the disclosed subject matter provides a matrix-structure and nonlocal-acceleration architecture in which the assembled operator 220 is represented and applied through one or more combinations of the nonlocal term 214, the Toeplitz kernel 216, the low-rank component 218, the Toeplitz/FFT acceleration stage 418, the shared memory region 708, the FFT engine 710, and the batch-eigensolver architecture 712, thereby enabling efficient repeated operator application, reduced memory footprint, improved throughput, and scalable spectral extraction across local, local-plus-nonlocal, effective-operator, and generalized target-spectrum embodiments. These structured-operator techniques may then support subsequent use of the computed spectral values in the verification and spectral correspondence workflow 500, the prime-spectral codec system 600, and the hardware and deployment embodiments 700.

In certain embodiments, the disclosed subject matter provides validation and benchmarking workflows configured to assess the quality, correspondence, stability, throughput, and utility of spectral values produced by the assembled operator 220 and the numerical solver and acceleration workflow 400. With reference to FIG. 1, FIG. 4, and FIG. 5, the validation and benchmarking functionality may be performed through cooperation among the eigensolver module 110, the verification module 112, the spectral output buffer 422, and the verification and spectral correspondence workflow 500, including the computed spectrum input 502, the reference spectrum input 504, the alignment engine 506, the error engine 508, the spacing-statistics engine 510, the rigidity engine 512, the spectral index 514, the computed ordinate 516, the reference ordinate 518, the count-matching module 520, and the certification output 522. In some embodiments, validation is performed for direct correspondence with a target reference spectrum. In other embodiments, validation is performed through local or long-range statistical measures, interval counts, convergence behavior, reproducibility tests, or throughput and resource measurements. Thus, validation and benchmarking are not limited to one mode of comparison, but instead comprise a flexible architecture for examiner-facing support, implementation qualification, and production deployment.

In certain embodiments, validation begins by loading one or more computed spectral values into the computed spectrum input 502. These computed spectral values may originate from a local self-adjoint realization, a local-plus-nonlocal realization, a matrix realization, an effective operator realization, a shifted target-window computation, or another disclosed operator embodiment. In some embodiments, the computed spectral values are supplied directly from the spectral output buffer 422 after convergence has been declared by the convergence test 420. In certain embodiments, each computed spectral value is accompanied by one or more associated metadata fields, such as a spectral index, a solver residual, a refinement status, a target window, a parity designation, a boundary-condition identifier, a truncation setting, a hardware execution profile, or another implementation descriptor. In some embodiments, such metadata improve traceability and permit validation results to be tied back to the exact computational configuration used to generate the spectral values.

In certain embodiments, reference data are supplied through the reference spectrum input 504. The reference spectrum input 504 may include one or more tabulated zeta-zero ordinates, one or more L-function zero datasets, one or more Maass-spectrum datasets, one or more automorphic-spectrum datasets, one or more synthetic or surrogate target spectra, one or more interval-count expectations, one or more asymptotic formulas, one or more statistical target distributions, or another reference basis for comparison. In some embodiments, the reference spectrum input 504 is stored locally. In other embodiments, it is retrieved from a database, network service, cloud environment, external dataset, or user-supplied file. In certain embodiments, the reference data are indexed so that a spectral index 514 corresponding to the computed ordinate 516 may be associated directly with a reference ordinate 518. In other embodiments, the reference data are compared through interval-based, distributional, or count-based methods without a strict one-to-one index pairing.

In certain embodiments, the alignment engine 506 aligns the computed spectrum input 502 with the reference spectrum input 504. In one representative embodiment, the alignment engine 506 performs direct ordinal matching such that a computed ordinate 516 corresponding to a selected spectral index 514 is paired with a reference ordinate 518 at the same index. In other embodiments, the alignment engine 506 performs local window matching, monotonic-order matching, nearest-reference matching, parity-specific matching, shifted-window alignment, or another comparison method suited to the selected spectral computation. In some embodiments, alignment is also used to reconcile finite truncation effects, computational offsets, missing data points, or adaptive-window extractions. In certain embodiments, the alignment engine 506 is configured to preserve the ordered nature of the computed spectral values while accommodating generalized target-spectrum workflows in which exact index equivalence is not assumed from the outset.

In certain embodiments, a validation pass criterion is defined by one or more objective acceptance conditions. By way of example, a computed spectral value may be accepted for a selected spectral index when an absolute-error metric, a relative-error metric, or both satisfy a selected threshold. In some embodiments, the relative-error metric is defined as the magnitude of the difference between a computed ordinate and a reference ordinate divided by the magnitude of the reference ordinate when the reference ordinate is nonzero. In certain embodiments, the threshold is predetermined for a run, stored as metadata with the run, or selected according to a target index range, target window, solver mode, or refinement mode.

In certain embodiments, interval validation is additionally or alternatively performed by requiring that a count of computed spectral values in a selected interval differ from an expected count by no more than a selected count tolerance. In further embodiments, local-spacing validation, rigidity validation, or both are accepted only when one or more corresponding test statistics, divergence measures, tolerance bands, or confidence criteria satisfy a selected acceptance rule. In some embodiments, a spectral-table entry is marked as certified only when the selected one-to-one, interval-based, or statistical acceptance condition has been satisfied.

In certain embodiments, the error engine 508 computes one or more comparison metrics for aligned spectral values. In some embodiments, the error engine 508 computes an absolute error defined as the magnitude of the difference between the computed ordinate 516 and the reference ordinate 518. In other embodiments, the error engine 508 computes a relative error defined by a normalized ratio such as |t_n(computed)−t_n(reference)|/|t_n(reference)|, where t_n(reference) is nonzero. In some embodiments, residual error, normalized residual, scaled discrepancy, interval error, or accumulated error over a selected spectral band is additionally or alternatively computed. In certain embodiments, the error engine 508 stores the resulting values in association with the spectral index 514 and passes one or more pass/fail determinations, threshold flags, or ranked discrepancy outputs to the certification output 522. In this way, the error engine 508 supports both fine-grained per-ordinate validation and aggregate numerical qualification of a solver run.

In certain embodiments, validation further includes count-based correspondence analysis performed by the count-matching module 520. In some embodiments, the count-matching module 520 compares the number of computed spectral values lying within a selected interval, height range, target window, or index band against a corresponding expected count from the reference spectrum input 504 or from an asymptotic counting relation. In certain embodiments, count matching is useful where exact one-to-one pairing is computationally inconvenient, where a target band is extracted using a shift or projection method, or where the desired comparison is between spectral density patterns rather than individual values. In some embodiments, count matching is also used as a consistency check in addition to direct ordinate comparison. In certain embodiments, the count-matching module 520 may compute absolute count discrepancy, normalized count discrepancy, count-density deviation, interval occupancy variance, or other count-based measures.

In certain embodiments, local statistical validation is performed through the spacing-statistics engine 510. In some embodiments, the spacing-statistics engine 510 computes nearest-neighbor spacings, normalized spacings, transformed gaps, higher-order differences, spacing histograms, empirical cumulative distributions, or other local spectral statistics derived from the ordered computed spectral values. In certain embodiments, these statistics are compared with corresponding statistics derived from the reference spectrum input 504 or from a target ensemble model. In some embodiments, the spacing-statistics engine 510 calculates one or more goodness-of-fit quantities, divergence scores, test statistics, or tolerance-based acceptance measures. In certain embodiments, spacing-based validation is particularly useful where the spectral values are intended to reproduce not only individual ordinates, but also local spacing structure characteristic of the target spectrum.

In certain embodiments, longer-range statistical validation is performed through the rigidity engine 512. In some embodiments, the rigidity engine 512 computes one or more long-range measures such as spectral rigidity, number variance, interval-count fluctuation, smoothed staircase deviation, or another statistic that captures correlations extending beyond nearest-neighbor spacing. In certain embodiments, the rigidity engine 512 operates over multiple interval lengths, index windows, or normalized spectral regions to determine whether the computed spectral values preserve long-range structure of the reference or target spectrum. In some embodiments, this type of analysis is especially useful for differentiating between spectral sequences that may match locally but fail to reproduce broader organization. In certain embodiments, the outputs of the rigidity engine 512 are incorporated into the certification output 522 together with local spacing statistics and direct ordinate comparison metrics.

In certain embodiments, the certification output 522 provides a structured validation result. In some embodiments, the certification output 522 comprises a human-readable report. In other embodiments, it comprises a machine-readable record, a metadata object, a signed verification record, a database entry, a threshold status flag, or a network-deliverable result. In certain embodiments, the certification output 522 states whether a selected computation satisfied one or more predetermined relative-error thresholds, absolute-error thresholds, count-consistency thresholds, local-spacing criteria, rigidity criteria, convergence criteria, or throughput requirements. In some embodiments, the certification output 522 further identifies the computational context used for validation, including one or more of the selected domain, selected boundary condition, truncation regime, discretization resolution, solver method, refinement method, structured-acceleration mode, acceptance rule, and hardware platform. This is useful not only for reproducibility, but also for downstream deployment in systems that rely on validated spectral tables or validated codec mappings.

In certain embodiments, benchmarking includes performance measurements in addition to mathematical or statistical validation. For example, one or more benchmark measurements may be taken with respect to time per spectral value, spectral values computed per unit time, batch throughput, memory utilization, accelerator occupancy, transform throughput, bandwidth usage, precision mode, refinement overhead, or energy consumption. In some embodiments, such measurements are gathered for the numerical solver and acceleration workflow 400 under one or more grid sizes, subspace sizes, truncation domains, block sizes, or hardware configurations. In certain embodiments, benchmark results are associated with the GPU server 702, the FPGA accelerator 704, the ASIC implementation 706, the photonic system 714, the quantum processor 716, or the cloud or distributed-computing environment 724 shown in FIG. 7. In some embodiments, these benchmark results are used to qualify a deployment for production use, to compare solver strategies, or to select between approximate and high-precision modes.

In certain embodiments, benchmarking also includes resource-scaling studies. In some embodiments, the number of extracted spectral values is varied to determine throughput scaling. In other embodiments, the truncation size, grid density, subspace dimension, block size, or transform length is varied to evaluate performance sensitivity. In certain embodiments, hardware comparisons are made across multiple implementations, such as CPU-only runs, GPU-accelerated runs, FPGA-assisted runs, or distributed-cloud runs. In some embodiments, these resource-scaling studies help determine which configuration is most appropriate for low-index enumeration, high-index target-window extraction, spectral-table generation, codec-database generation, or network service deployment. In certain embodiments, the results of such studies are stored together with the certification output 522 or other benchmark metadata so that an implementation can later be reproduced or optimized systematically.

In certain embodiments, the disclosed validation and benchmarking framework is used not only for zeta-target embodiments, but also for generalized target-spectrum embodiments. For example, the reference spectrum input 504 may comprise Dirichlet L-function zero data, Maass-form spectrum data, automorphic-spectrum data, or surrogate spectral targets. In some embodiments, the alignment engine 506, the error engine 508, the spacing-statistics engine 510, the rigidity engine 512, and the count-matching module 520 are configured differently depending on the selected target family. In certain embodiments, direct ordinate comparison is emphasized for one target, whereas spacing-statistics or count-consistency validation is emphasized for another. Thus, the validation and benchmarking architecture is expressly broad enough to support multiple target-spectrum pathways and to preserve flexibility during prosecution and later implementation.

Accordingly, in certain embodiments, the disclosed subject matter provides a validation and benchmarking architecture in which the computed spectrum input 502 is compared against the reference spectrum input 504 through the alignment engine 506, the error engine 508, the spacing-statistics engine 510, the rigidity engine 512, the spectral index 514, the computed ordinate 516, the reference ordinate 518, the count-matching module 520, and the certification output 522, while throughput, scaling, precision, and resource metrics are collected with respect to one or more solver and hardware configurations. The resulting validation and benchmark outputs may then support examiner-facing disclosure, implementation qualification, spectral-table generation, codec-table generation, API deployment, and continued use of the disclosed systems within the prime-spectral codec system 600 and the hardware and deployment embodiments 700.

In certain embodiments, the disclosed subject matter provides a prime-spectral codec system 600 configured to encode, compress, decode, reconstruct, store, transmit, and otherwise process prime-derived, factorization-derived, or other integer-derived data using spectral-domain representations obtained from the disclosed recognition-derived operator framework. With reference to FIG. 1 and FIG. 6, the codec module 114 may cooperate with the prime-spectral codec system 600 to receive an input sequence 602, generate one or more prime-indexed or spectral-indexed representations through the factorization module 604, the prime-index mapper 606, and the spectral lookup 608, transform the resulting data through the transform stage 610, encode the transformed data through the entropy coder 612 to produce a compressed output 614, and later reconstruct the data through the compressed input 616, the entropy decoder 618, the spectral reconstructor 620, the inverse mapper 622, the integer reconstruction module 624, and the decoded output 626. In some embodiments, the prime-spectral codec system 600 is used as a downstream consumer of previously computed spectral values. In other embodiments, the codec system 600 is integrated more tightly with the overall spectral computation system 100 so that spectral values are generated, validated, cached, and used for compression within one unified architecture.

In certain embodiments, the input sequence 602 comprises a sequence of values derived from prime structure. For example, the input sequence 602 may comprise prime gaps, ordered primes, prime-indexed metadata, factorized integer sequences, Goldbach-related data, twin-prime index data, semiprime-related data, divisor-structure data, arithmetic-function data, prime-support indicator sequences, encoded integer events, or other integer-derived information capable of being related to prime indices or factorization patterns. In some embodiments, the input sequence 602 instead comprises general integer data that can be factorized into primes or mapped into a prime-indexed representation. In certain embodiments, the codec is especially useful where the source data contain regularity, recurrence, or compressible structure when viewed through prime-index or spectral-gap coordinates rather than through raw integer coordinates. In this way, the disclosed codec is not limited to one benchmark dataset, but instead supports a broader family of data streams that can be represented through prime-spectral mappings.

In certain embodiments, the factorization module 604 processes the input sequence 602 to identify one or more prime-related components. In some embodiments, the factorization module 604 performs complete prime factorization of each integer in the input sequence 602. In other embodiments, the factorization module 604 extracts partial prime structure, dominant prime components, prime supports, prime exponents, prime indices, or a normalized factorization signature. In certain embodiments, the factorization module 604 may operate through direct factorization, table lookup, sieve-assisted decomposition, cached decomposition, probabilistic factorization followed by confirmation, or another prime-resolution method. In some embodiments, where the input sequence 602 is already given in prime-gap or prime-index form, the factorization module 604 may perform identity handling, normalization, or structural conversion rather than full factorization. In certain embodiments, the output of the factorization module 604 comprises one or more prime identifiers suitable for use by the prime-index mapper 606.

In certain embodiments, the prime-index mapper 606 associates one or more prime-related quantities with one or more spectral indices or spectral positions. In one representative embodiment, each prime p_k is associated with an integer index k corresponding to its position in the ordered prime sequence, and the prime-index mapper 606 uses that index to access a corresponding spectral value, spectral ordinate, or spectral interval. In some embodiments, the prime-index mapper 606 processes not only single prime indices, but also tuples of indices, multiplicities, exponents, ordered factorizations, normalized signatures, or prime-gap-derived indices. In certain embodiments, the mapping performed by the prime-index mapper 606 may be direct, table-driven, computed, interpolated, cached, or a combination thereof. In some embodiments, the mapping is one-to-one for certain data classes. In other embodiments, the mapping is many-to-one, one-to-many, or augmented with side information sufficient to permit lossless reconstruction. In all such cases, the prime-index mapper 606 transforms prime-related input structure into a form aligned with the spectral organization generated by the disclosed operator framework.

In certain embodiments, the spectral lookup 608 retrieves spectral values or related spectral metadata associated with the prime indices or prime-derived structures produced by the prime-index mapper 606. In some embodiments, the spectral lookup 608 accesses a precomputed and optionally validated spectral table generated by the numerical solver and acceleration workflow 400 and optionally certified through the verification and spectral correspondence workflow 500. In certain embodiments, the spectral lookup 608 may retrieve absolute spectral values, spectral gaps, cumulative spectral positions, normalized spectral values, target-window-specific values, or approximated values based on interpolation or extrapolation. In some embodiments, the spectral lookup 608 also retrieves metadata such as validation status, residual bounds, index ranges, parity tags, or confidence levels. In certain embodiments, the spectral lookup 608 is implemented through local memory, cache, database access, compressed table access, remote query, API-based access, or another retrieval mechanism. In some embodiments, the spectral lookup 608 may trigger on-demand spectral computation when a requested spectral value is not already stored.

In certain embodiments, the transform stage 610 generates a coding-oriented representation from the spectral values obtained through the spectral lookup 608. In one representative embodiment, the transform stage 610 computes spectral gaps, such as Delta t_k=t_k−t_(k−1), where t_k denotes a selected spectral value associated with a prime index k. In other embodiments, the transform stage 610 computes first differences, higher-order differences, delta-of-delta quantities, normalized gaps, residuals relative to a predictor, arithmetic-coded symbol classes, run-length-friendly symbol streams, or mixed representations combining raw indices, spectral values, and transformed gaps. In some embodiments, the transform stage 610 is configured to reduce entropy, smooth local variation, regularize symbol frequencies, or otherwise improve coding efficiency relative to direct representation of raw prime-derived data. In certain embodiments, predictive models, context models, local statistical models, or target-spectrum-informed models may be used to define residuals or transformed symbols. In this way, the transform stage 610 provides a flexible bridge between spectral representation and entropy coding.

In certain embodiments, the entropy coder 612 encodes the transformed representation into the compressed output 614. In some embodiments, the entropy coder 612 uses arithmetic coding. In other embodiments, the entropy coder 612 uses range coding, ANS coding, Huffman coding, adaptive coding, static coding, context-based coding, block coding, or another lossless coding method. In certain embodiments, the entropy coder 612 assigns shorter codewords or lower coding cost to transformed symbols having higher modeled or observed probability. In some embodiments, coding contexts are selected based on prime-index neighborhood, local spectral-gap history, factorization pattern, target dataset class, or validation level of the underlying spectral values. In certain embodiments, the compressed output 614 may be written to storage, transmitted over a network, stored as a file, embedded in a protocol message, or passed to a downstream application. In some embodiments, auxiliary metadata such as index offsets, table versions, transform parameters, predictor identifiers, or reconstruction modes are also encoded to preserve lossless reversibility.

In certain embodiments, decoding is initiated by receiving the compressed input 616. The entropy decoder 618 applies a decoding procedure corresponding to the encoding performed by the entropy coder 612, thereby recovering transformed symbols, residuals, spectral-gap values, or other intermediate representations. In some embodiments, the entropy decoder 618 is configured for arithmetic decoding. In other embodiments, it is configured for range decoding, ANS decoding, Huffman decoding, adaptive decoding, or another inverse coding process. In certain embodiments, the entropy decoder 618 also recovers side information, context-state information, table identifiers, prediction parameters, or reconstruction flags required for exact inversion of the encoded representation. In some embodiments, the output of the entropy decoder 618 is passed to the spectral reconstructor 620 for conversion back into spectral coordinates or prime-index-related coordinates.

In certain embodiments, the spectral reconstructor 620 rebuilds one or more spectral-domain quantities from the decoded transform output. In one representative embodiment, the spectral reconstructor 620 reconstructs a sequence of spectral values from decoded spectral gaps by cumulative summation or ordered accumulation. In other embodiments, the spectral reconstructor 620 reconstructs predicted spectral values plus residual corrections, reconstructs normalized values into absolute values, reconstructs index-spectral tuples, or reconstructs mixed symbolic structures used during encoding. In some embodiments, the spectral reconstructor 620 uses a cached spectral base value, interval anchor, or predictor state to invert a transformed coding stream. In certain embodiments, the reconstructed spectral values are then supplied to the inverse mapper 622. In some embodiments, the spectral reconstructor 620 also verifies consistency of decoded values against one or more index, ordering, or checksum conditions before forwarding them.

In certain embodiments, the inverse mapper 622 converts reconstructed spectral-domain values into prime-index-domain or prime-structure-domain representations. In one representative embodiment, the inverse mapper 622 identifies a prime index corresponding to each reconstructed spectral value or spectral position. In other embodiments, the inverse mapper 622 reconstructs factor tuples, multiplicity information, support sets, prime-gap labels, or index bundles used to recover the original data stream. In some embodiments, the inverse mapper 622 performs direct table inversion. In other embodiments, it performs search, interpolation inversion, residual-based inversion, or assisted inversion using metadata recovered from the compressed input 616. In certain embodiments, the inverse mapper 622 need not invert an exact one-to-one map for all intermediate structures so long as the overall pipeline remains lossless with the aid of encoded side information. In some embodiments, once the prime-index or factorization structure has been reconstructed, the integer reconstruction module 624 rebuilds the original integer-derived data values.

In certain embodiments, the codec pipeline is verified as lossless by applying one or more reconstruction checks before outputting the decoded output 626. By way of example, the reconstruction checks may include equality of a reconstructed integer sequence with an original integer sequence, equality of a reconstructed prime-index sequence with an original prime-index sequence, consistency of a reconstructed factorization with an encoded factorization signature, or checksum, hash, or parity verification associated with a coded block. In some embodiments, a decoded block is marked valid only when the selected reconstruction check has been satisfied.

In certain embodiments, the integer reconstruction module 624 reconstructs the original source data using prime identities, factor exponents, index mappings, sequence ordering, auxiliary metadata, and one or more reconstruction rules specific to the source class. For example, where the input sequence 602 comprised integers given by prime factorization, the integer reconstruction module 624 may recombine recovered prime powers into exact integers. Where the input sequence 602 comprised prime-gap data, the integer reconstruction module 624 may reconstruct the original ordered prime or gap sequence. Where the input sequence 602 comprised another prime-derived structure, the integer reconstruction module 624 may apply the appropriate inverse combinational or algebraic rule. In certain embodiments, the result is delivered as the decoded output 626. In some embodiments, the decoded output 626 is bitwise identical to the original source stream. In other embodiments, the decoded output 626 is logically identical under a normalized representation convention. Thus, in certain embodiments, the disclosed codec is lossless.

In certain embodiments, the prime-spectral codec system 600 supports streaming operation. In some embodiments, the input sequence 602 is processed incrementally, one block, one interval, one factorization event, or one spectral window at a time. In certain embodiments, the spectral lookup 608 and the transform stage 610 may operate on rolling windows, incremental table updates, or partially cached spectral ranges. In some embodiments, the entropy coder 612 and the entropy decoder 618 maintain evolving context state across a stream. In certain embodiments, streaming mode is useful for very large prime-derived datasets, continuously generated data, distributed computation logs, network transport, or cloud service deployment. In some embodiments, the streaming embodiment preserves lossless reconstruction while reducing working-memory requirements relative to fully offline processing.

In certain embodiments, the codec supports multiple operating modes depending on implementation goals. In a first mode, the codec prioritizes maximum compression ratio for archival storage. In a second mode, the codec prioritizes decoding speed for rapid reconstruction. In a third mode, the codec prioritizes low-memory streaming behavior. In a fourth mode, the codec uses only validated spectral values from certified spectral tables. In a fifth mode, the codec permits use of estimated or interpolated spectral values together with additional side information sufficient to preserve lossless reconstruction. In certain embodiments, these modes may be selected by user input, deployment policy, hardware availability, dataset class, regulatory requirement, or another control mechanism within the codec module 114 or the hardware and deployment embodiments 700.

In certain embodiments, the prime-spectral codec system 600 is implemented on one or more hardware platforms shown in FIG. 7. For example, the factorization module 604, prime-index mapper 606, spectral lookup 608, transform stage 610, entropy coder 612, entropy decoder 618, spectral reconstructor 620, inverse mapper 622, and integer reconstruction module 624 may be implemented on the GPU server 702, the FPGA accelerator 704, the ASIC implementation 706, or within the cloud or distributed-computing environment 724. In some embodiments, factorization and lookup operations are executed on a CPU or server while transform coding and entropy coding are accelerated on a GPU or FPGA. In certain embodiments, codec lookup tables are stored in the storage subsystem 722 and accessed through the network interface 718 by a client system 720. In some embodiments, the disclosed codec thereby supports both local and service-based deployment.

Accordingly, in certain embodiments, the disclosed subject matter provides a prime-spectral codec architecture in which the input sequence 602 is processed through the factorization module 604, the prime-index mapper 606, the spectral lookup 608, the transform stage 610, and the entropy coder 612 to generate the compressed output 614, and is subsequently reconstructed through the compressed input 616, the entropy decoder 618, the spectral reconstructor 620, the inverse mapper 622, the integer reconstruction module 624, and the decoded output 626. This codec architecture permits prime-derived or integer-derived data to be represented in a recognition-derived spectral domain that supports efficient lossless compression while remaining integrated with the same overall spectral computation system 100, validation workflows 500, and hardware and deployment embodiments 700 used for spectral extraction and target association.

In certain embodiments, the disclosed subject matter is implemented through one or more hardware and deployment embodiments 700 configured to construct, discretize, solve, validate, encode, decode, store, transmit, or otherwise process recognition-derived spectral data. With reference to FIG. 1, FIG. 4, FIG. 6, and FIG. 7, the accelerator interface 116, the numerical solver and acceleration workflow 400, the prime-spectral codec system 600, and the hardware and deployment embodiment 700 may cooperate to execute one or more portions of the disclosed methods on a GPU server 702, an FPGA accelerator 704, an ASIC implementation 706, a shared memory region 708, an FFT engine 710, a batch-eigensolver architecture 712, a photonic system 714, a quantum processor 716, a network interface 718, a client system 720, a storage subsystem 722, and a cloud or distributed-computing environment 724. In some embodiments, the disclosed subject matter is implemented on a single machine. In other embodiments, it is distributed across multiple machines, accelerators, services, or computational tiers. In still other embodiments, different portions of the workflow are assigned to different hardware types according to throughput, latency, memory, precision, or deployment constraints.

In certain embodiments, the GPU server 702 is configured to accelerate operator application, grid-based discretization, Krylov-subspace generation, Lanczos recursion, block eigensolver execution, refinement, spectral-table generation, transform-based matrix-vector multiplication, and codec operations. In some embodiments, the GPU server 702 executes many repeated sparse-local and structured-nonlocal operator applications in parallel. In certain embodiments, the shared memory region 708 is used to stage vector segments, stencil coefficients, Toeplitz coefficients, transform buffers, reduction data, or block-eigensolver state. In some embodiments, the GPU server 702 supports high-throughput extraction of multiple spectral values in batch or block form, while also accelerating arithmetic coding, range coding, symbol transforms, lookup-table traversal, or reconstruction tasks associated with the prime-spectral codec system 600. In certain embodiments, the GPU server 702 operates under single precision, double precision, mixed precision, adaptive precision, or staged precision regimes depending on the desired balance between throughput and numerical accuracy.

In certain embodiments, the FPGA accelerator 704 is configured to perform one or more fixed-function, semi-configurable, or pipelined tasks associated with the disclosed workflows. In some embodiments, the FPGA accelerator 704 implements all or part of the FFT engine 710, one or more sparse or banded operator kernels, one or more Toeplitz or convolution kernels, one or more low-rank update routines, one or more block-eigensolver data paths, or one or more entropy-coding pipelines. In certain embodiments, the FPGA accelerator 704 is used to reduce latency, improve energy efficiency, or permit a customized arithmetic format matched to a particular deployment target. In some embodiments, the FPGA accelerator 704 is coupled to one or more high-bandwidth memory devices or external vector buffers, permitting large structured spectral computations or streaming codec operations. In certain embodiments, the FPGA accelerator 704 is deployed as a co-processor to a CPU or GPU host, while in other embodiments it serves as a primary engine for selected portions of the operator, solver, or codec pipeline.

In certain embodiments, the ASIC implementation 706 provides an application-specific realization of one or more portions of the disclosed subject matter. In some embodiments, the ASIC implementation 706 includes dedicated circuitry for sparse-local operator application, transform-domain structured multiplication, block eigensolver support, entropy coding, table lookup, interval-count verification, or another repeated high-throughput operation. In certain embodiments, the ASIC implementation 706 is advantageous where a stable production deployment requires reduced energy consumption, reduced latency, smaller physical footprint, higher sustained throughput, or a tightly controlled numerical path. In some embodiments, the ASIC implementation 706 is configured for spectral-table generation. In other embodiments, the ASIC implementation 706 is configured for codec execution, cloud inference, or embedded deployment in a network appliance or research device. In certain embodiments, the ASIC implementation 706 may include one or more programmable control regions so that parameter settings, target ranges, transform lengths, or coding contexts can be updated without redesigning the entire device.

In certain embodiments, the shared memory region 708 and the FFT engine 710 support repeated reuse of local or structured computational data. In some embodiments, the shared memory region 708 stores stencil values, boundary-condition data, basis coefficients, vector blocks, transform coefficients, kernel fragments, or intermediate reduction results for rapid access by one or more processing elements. In certain embodiments, the FFT engine 710 provides one or more forward transforms, inverse transforms, convolution support operations, or spectral-domain multiplication routines used by the Toeplitz/FFT acceleration stage 418. In some embodiments, the FFT engine 710 is implemented in software running on one or more processors. In other embodiments, it is realized in programmable logic or fixed-function circuitry. In certain embodiments, the shared memory region 708 and the FFT engine 710 operate together to reduce memory traffic and increase throughput during repeated matrix-vector products, refinement cycles, spectral-table generation, or codec transforms.

In certain embodiments, the batch-eigensolver architecture 712 is configured to compute multiple spectral values concurrently or in pipelined form. In some embodiments, the batch-eigensolver architecture 712 receives multiple initial vectors, multiple target windows, multiple shift parameters, or multiple problem instances and processes them in parallel. In certain embodiments, such batching amortizes setup cost associated with operator construction, transform planning, coefficient loading, and basis initialization. In some embodiments, the batch-eigensolver architecture 712 is useful for populating a spectral database, generating codec lookup tables, performing large-scale validation studies, or servicing concurrent network requests for spectral data. In certain embodiments, the batch-eigensolver architecture 712 is implemented on the GPU server 702, the FPGA accelerator 704, the ASIC implementation 706, or the cloud or distributed-computing environment 724.

In certain embodiments, the photonic system 714 provides an analog, optical, or wave-based realization of one or more portions of the disclosed operator framework. In some embodiments, the photonic system 714 implements a refractive-index profile, propagation medium, resonant cavity, waveguide structure, or analogous physical system corresponding to one or more aspects of the transformed potential output 208 or the assembled operator 220. In certain embodiments, resonant modes, guided modes, interference patterns, or measured frequencies of the photonic system 714 are associated with ordered spectral values usable within the verification and spectral correspondence workflow 500 or the broader system architecture. In some embodiments, the photonic system 714 operates as a hardware accelerator, as an analog co-processor, or as a validation platform for selected operator embodiments. In certain embodiments, the photonic system 714 is used to obtain approximate spectral values which are later refined numerically.

In certain embodiments, the quantum processor 716 provides a quantum-computational embodiment of one or more portions of the disclosed subject matter. In some embodiments, the quantum processor 716 is configured to implement a Hamiltonian-simulation workflow, a phase-estimation workflow, a variational eigenvalue workflow, an amplitude-estimation workflow, or another quantum routine associated with spectral extraction, refinement, or target-window identification. In certain embodiments, the quantum processor 716 acts on a discretized, encoded, truncated, or effective version of the assembled operator 220. In some embodiments, outputs from the quantum processor 716 are used directly as approximate spectral ordinates. In other embodiments, outputs from the quantum processor 716 are used to initialize or narrow a classical refinement process. In certain embodiments, the quantum processor 716 may also be used in hybrid deployments in which a classical solver computes local components while a quantum subroutine treats selected structured or high-dimensional subproblems.

In certain embodiments, the network interface 718 provides communication between one or more computational engines and one or more users, client devices, storage systems, or remote services. In some embodiments, the network interface 718 transmits requests for specific spectral indices, target windows, codec operations, or validation reports. In certain embodiments, the client system 720 comprises a workstation, laptop, desktop, terminal, mobile device, research console, server-side application, or automated software client configured to submit such requests and receive responses. In some embodiments, the storage subsystem 722 stores operator parameters, structured kernel data, transform coefficients, spectral tables, codec tables, validation records, compressed datasets, decoded outputs, benchmark reports, or deployment logs. In certain embodiments, the storage subsystem 722 includes one or more local drives, network-attached devices, object stores, database systems, cache layers, or archival media.

In certain embodiments, the cloud or distributed-computing environment 724 distributes the disclosed workflows across multiple nodes, machines, accelerators, or services. In some embodiments, one node performs operator construction, another performs discretization, another performs batch eigensolution, another performs validation, and another performs codec operations. In certain embodiments, workloads are partitioned by target index range, spectral window, dataset block, hardware type, user account, or service tier. In some embodiments, the cloud or distributed-computing environment 724 supports a network-accessible API in which a user requests one or more spectral values, validation results, encoded bitstreams, or decoded reconstructions and receives a result without locally performing the entire computation. In certain embodiments, the distributed environment is used for high-throughput precomputation of spectral databases and codec lookup structures, while lightweight client systems 720 access those resources on demand.

In certain embodiments, the disclosed hardware and deployment embodiments 700 support hybrid execution models. For example, operator construction and control logic may run on a CPU or host process, sparse-local and structured operator applications may run on the GPU server 702, low-latency transform stages may run on the FPGA accelerator 704, validation and storage functions may run in the cloud or distributed-computing environment 724, and codec encoding or decoding may be performed either centrally or on the client system 720. In certain embodiments, the same hybrid model may be adjusted dynamically according to workload type, such as low-index exploratory computation, high-index certified extraction, spectral-table generation, streaming compression, or network query servicing. In some embodiments, workload routing decisions are made according to available hardware, latency constraints, throughput goals, energy targets, numerical precision requirements, or service-level agreements.

In certain embodiments, the disclosed subject matter is embodied in software stored on one or more non-transitory computer-readable media and executed by one or more processors associated with the GPU server 702, the FPGA accelerator 704, the ASIC implementation 706, the photonic system 714, the quantum processor 716, the client system 720, or the cloud or distributed-computing environment 724. In some embodiments, such software causes one or more processors or processing systems to carry out operator construction, domain selection, boundary enforcement, discretization, eigensolution, refinement, validation, spectral-table generation, prime-index mapping, transform coding, entropy coding, decoding, inverse mapping, reconstruction, benchmarking, storage, network delivery, or another disclosed operation. In certain embodiments, one or more portions of the disclosed subject matter are carried out through firmware, programmable logic, fixed-function hardware, or combinations thereof rather than through general-purpose software alone. Thus, the present disclosure is not limited to any single implementation layer.

Accordingly, in certain embodiments, the hardware and deployment embodiments 700 provide a flexible execution architecture in which the GPU server 702, the FPGA accelerator 704, the ASIC implementation 706, the shared memory region 708, the FFT engine 710, the batch-eigensolver architecture 712, the photonic system 714, the quantum processor 716, the network interface 718, the client system 720, the storage subsystem 722, and the cloud or distributed-computing environment 724 may be used individually or in combination to implement the disclosed operator constructions, numerical discretization and solver workflows, nonlocal acceleration strategies, validation and benchmarking workflows, and prime-spectral codec operations. This hardware architecture therefore supports local, remote, embedded, accelerator-based, service-based, and hybrid deployments of the overall spectral computation system 100.

In one representative computational embodiment, the discretization module 108 constructs a logarithmic grid on a truncated computational domain, the local kinetic term is represented by a finite-difference stencil yielding a sparse symmetric matrix contribution, and the transformed potential output 208 is represented as a diagonal matrix contribution. In some embodiments, the eigensolver module 110 applies a Krylov-subspace workflow including a Lanczos recursion, Ritz-value extraction, and a refinement procedure. In certain embodiments, reorthogonalization is performed at selected intervals or in response to a loss-of-orthogonality condition, one or more refined spectral values are stored in the spectral output buffer 422 together with residual or certification metadata, and at least one stored spectral value is later retrieved through a spectral table or lookup structure for validation, comparison, or codec processing.

The following worked examples are provided to illustrate representative embodiments of the disclosed subject matter and to demonstrate how the disclosed systems may be configured for spectral extraction, target association, validation, compression, and deployment. These examples are illustrative and non-limiting. Unless expressly stated otherwise, no particular numerical value, throughput value, truncation setting, solver setting, validation threshold, or hardware configuration described in an example should be understood as limiting the broader scope of the disclosed subject matter. Rather, each example is intended to show one or more practical ways in which the overall spectral computation system 100, the operator derivation and structure arrangement 200, the domain and boundary embodiment 300, the numerical solver and acceleration workflow 400, the verification and spectral correspondence workflow 500, the prime-spectral codec system 600, and the hardware and deployment embodiment 700 may be used in practice.

In a first worked example, the disclosed subject matter is used for low-index spectral extraction associated with non-trivial zeta-zero ordinates. In this example, the operator construction module 106 generates an assembled operator 220 from the kinetic term 210 and the local potential term 212, where the transformed potential output 208 is given by V_RP(x)=cosh(x)−1. The operator is realized on the half-line domain 302 with a Dirichlet boundary condition 308 and a self-adjoint domain specification 318. The discretization module 108 constructs a finite matrix representation on a logarithmic grid at the grid construction stage 402 and the discretization stage 404. The eigensolver module 110 generates one or more starting vectors through the initial vector stage 406, builds a Krylov subspace through the Krylov subspace stage 408, applies a Lanczos recursion at the Lanczos recursion stage 410, and extracts approximate spectral ordinates at the Ritz extraction stage 414. The refinement stage 416 then improves the resulting values before storing them in the spectral output buffer 422. The verification module 112 compares the resulting computed spectrum input 502 to a reference spectrum input 504 comprising tabulated zeta-zero values, using the alignment engine 506 and the error engine 508 to assess correspondence between the computed ordinate 516 and the reference ordinate 518 at a selected spectral index 514. In certain embodiments, the certification output 522 records that the extracted low-index values satisfy one or more selected validation thresholds. This example demonstrates that the disclosed framework supports direct extraction and validation of ordered low-index spectral values in a self-adjoint operator embodiment.

In a second worked example, the disclosed subject matter is used for high-index target-window extraction. In this example, the operator construction module 106 generates a shifted or target-window-adapted realization of the assembled operator 220 suitable for computation in a selected spectral region rather than only from the lowest index upward. The selected realization may be defined on the truncated computational domain 306 with a Robin boundary condition 312 or another boundary condition selected to reduce edge artifacts in the relevant target band. The numerical solver and acceleration workflow 400 may employ a selected shift, target band, projection, or solver adaptation so that the Krylov subspace stage 408 and the Lanczos recursion stage 410 preferentially resolve spectral values in the desired region. In some embodiments, the refinement stage 416 is applied only to values in a target band, thereby reducing computational cost. The count-matching module 520 may be used to compare the number of extracted spectral values within the selected interval against an expected count from the reference spectrum input 504, while the error engine 508 may evaluate per-ordinate discrepancies for values that have been aligned by the alignment engine 506. This example shows that the disclosed system is not limited to strictly sequential low-order extraction, but also supports high-index or target-window computation and validation.

In a third worked example, the disclosed subject matter is used for prime-gap compression. In this example, the input sequence 602 of the prime-spectral codec system 600 comprises a sequence of prime gaps. The factorization module 604 may be bypassed, simplified, or used only for normalization because the source data are already prime-derived. The prime-index mapper 606 associates each gap location or related prime identifier with a corresponding prime index, and the spectral lookup 608 retrieves one or more spectral values associated with those indices from a precomputed spectral table generated by the numerical solver and acceleration workflow 400. The transform stage 610 computes one or more transformed coding quantities, such as spectral gaps, delta values, residual values, or combinations thereof, and the entropy coder 612 compresses the transformed representation to produce the compressed output 614. For decoding, the entropy decoder 618 recovers the transformed symbol stream, the spectral reconstructor 620 recovers the relevant spectral-domain data, the inverse mapper 622 identifies the corresponding prime-index-domain representation, and the integer reconstruction module 624 rebuilds the original prime-gap stream to produce the decoded output 626. In certain embodiments, the decoded output 626 is losslessly identical to the original input sequence 602. This example demonstrates that spectral values generated from the disclosed operator architecture may be repurposed as a coding coordinate system for compression of prime-derived data.

In a fourth worked example, the disclosed subject matter is used in a streaming codec embodiment. In this example, the input sequence 602 is not processed as a single fixed offline dataset, but instead arrives in blocks, windows, packets, or incremental segments. The prime-spectral codec system 600 maintains state across segments, including one or more entropy-coding contexts, one or more predictor contexts, one or more spectral lookup caches, or one or more prior reconstructed values. The spectral lookup 608 may access a local cache of spectral values for one interval while also requesting additional values from the storage subsystem 722 or the cloud or distributed-computing environment 724 for a subsequent interval. The transform stage 610 may compute rolling deltas or predictor residuals, and the entropy coder 612 may emit an evolving compressed output 614 without waiting for the entire dataset to be available. On the decode side, the entropy decoder 618 and the spectral reconstructor 620 may similarly operate in blockwise or incremental fashion to produce the decoded output 626 as a stream. This example illustrates that the disclosed codec is suitable not only for archival compression, but also for real-time or near-real-time prime-derived data processing.

In a fifth worked example, the disclosed subject matter is implemented in a hardware-accelerated embodiment for large-scale spectral extraction. In this example, the GPU server 702 is used to accelerate the numerical solver and acceleration workflow 400. The shared memory region 708 stores one or more vector blocks, kernel coefficients, or transform buffers associated with the Toeplitz/FFT acceleration stage 418, while the batch-eigensolver architecture 712 processes multiple starting vectors, blocks, or target windows concurrently. In some embodiments, one or more structured nonlocal terms represented by the Toeplitz kernel 216 or the low-rank component 218 are applied using the FFT engine 710 or a software-equivalent transform engine running on the GPU server 702. The resulting spectral values are written to the spectral output buffer 422 and passed to the verification module 112 for comparison and certification. In certain embodiments, the same hardware deployment also generates a spectral table later used by the prime-spectral codec system 600. This example demonstrates that the disclosed architecture supports practical high-throughput deployment on modern accelerator hardware and that the solver, validation, and codec branches may share the same underlying spectral infrastructure.

In a sixth worked example, the disclosed subject matter is used in an alternative target-spectrum embodiment. In this example, the operator construction module 106 generates a generalized target-spectrum operator rather than an embodiment directed solely to zeta-zero association. The modified assembled operator 220 may incorporate a weighting, character dependence, basis adaptation, boundary adaptation, or another target-specific structural change suitable for association with a Dirichlet L-function spectrum, a Maass-form-related spectrum, an automorphic spectrum, or another selected target. The resulting spectral values are extracted using the same or similar numerical solver and acceleration workflow 400 used in the zeta-target embodiments. The verification module 112 receives a reference spectrum input 504 appropriate to the selected target family and adapts the alignment engine 506, the error engine 508, the spacing-statistics engine 510, the rigidity engine 512, and the count-matching module 520 accordingly. In some embodiments, the resulting spectral values are also used in a target-specific codec or indexing workflow. This example demonstrates that the disclosed architecture is not confined to one mathematical target, but instead supports a broader family of target-spectrum realizations within the same overall computational framework.

In a further representative embodiment, the disclosed subject matter is provided as a network-accessible spectral service. In this example, the cloud or distributed-computing environment 724 hosts precomputed spectral tables, operator data, validation records, or codec structures, and one or more client systems 720 submit requests through the network interface 718. A request may specify a spectral index, a target interval, a codec operation, a compressed data retrieval, a validation report, or another service call. The service may then retrieve one or more stored values from the storage subsystem 722, compute additional values on demand using the GPU server 702 or the FPGA accelerator 704, validate the results through the verification module 112, and return one or more ordinates, reports, encoded datasets, decoded datasets, or metadata objects to the client system 720. In this way, the disclosed subject matter may be deployed not only as a local research tool or embedded appliance, but also as a remote-access computational platform.

The foregoing worked examples illustrate that the disclosed subject matter supports a wide range of practical implementations, including low-index extraction, high-index target-window computation, prime-gap compression, streaming codec operation, hardware acceleration, generalized target-spectrum adaptation, and network-accessible deployment. These examples are not intended to be exhaustive, and one of ordinary skill in the art will recognize that features of one example may be combined with features of another example without departing from the scope of the present disclosure.

The disclosed subject matter is not limited to the particular embodiments expressly described above. Rather, numerous alternative embodiments, structural variations, computational substitutions, and deployment modifications may be used while remaining within the scope of the present disclosure. In certain embodiments, the alternative embodiments and variations described below may be implemented individually or in combination with one another. In some embodiments, one or more such variations may be selected to improve numerical stability, expand claim support, adapt the disclosed subject matter to a different target spectrum, tailor the implementation to a particular hardware platform, or optimize a selected tradeoff among precision, throughput, storage, latency, and coding efficiency. Accordingly, the following alternatives are intended to broaden and clarify the range of implementations supported by the present disclosure, and not to narrow the embodiments previously described.

In certain embodiments, alternative operator families may be employed. For example, while one representative embodiment uses a Schrödinger-type operator of the form H_RP psi(x)=−d\hat{ }2 psi(x)/dx\hat{ }2+V_RP(x) psi(x), other embodiments may use transformed-coordinate operators, weighted operators, matrix-only operators, basis-projected operators, graph-based operators, finite-volume operators, local-plus-nonlocal operators, reduced-order operators, integral operators, or effective operators derived from a recognition-evolution relation. In some embodiments, the operator is realized directly in continuum symbolic form. In other embodiments, the operative object for computation is a finite matrix or matrix-free routine that is only indirectly associated with a continuum operator. In still other embodiments, an operator family is selected adaptively according to the intended target spectrum, solver method, or hardware deployment. Thus, the disclosed subject matter expressly encompasses a family of recognition-derived spectral operators rather than a single isolated symbolic formula.

In certain embodiments, alternative transforms of the recognition cost function may be employed. For example, while one representative embodiment uses x=ln(X) and V_RP(x)=J(e\hat{ }x)=cosh(x)−1, other embodiments may employ shifted logarithmic coordinates, scaled logarithmic coordinates, translated coordinate systems, normalized coordinate transforms, piecewise transforms, basis-adapted transforms, or target-window transforms. In some embodiments, one or more additive or multiplicative factors are introduced for numerical conditioning, interval localization, asymptotic matching, or basis compatibility. In certain embodiments, these alternative transforms preserve the underlying recognition-derived character of the construction while adapting the resulting operator to a selected computational or target-spectrum regime.

In certain embodiments, alternative domains and boundary realizations may be employed. For example, the operator may be realized on the half-line domain 302, the full-line domain 304, the truncated computational domain 306, a parity-restricted domain, a finite basis span, or another selected coordinate or functional domain. Likewise, the operator may be paired with the Dirichlet boundary condition 308, the Neumann boundary condition 310, the Robin boundary condition 312, the mixed boundary condition 314, the Friedrichs-extension embodiment 316, the self-adjoint domain specification 318, or another analytical or computationally equivalent realization. In some embodiments, one boundary regime is selected for low-index extraction and another is selected for high-index target-window extraction. In some embodiments, one boundary regime is selected for direct zeta-target computation and another is selected for generalized target-spectrum use. In this way, the present disclosure preserves flexibility with respect to domain architecture and avoids confinement to a single origin condition, interval type, or extension theory.

In certain embodiments, alternative eigensolver and numerical strategies may be employed. Although a Krylov/Lanczos workflow is representative, the eigensolver module 110 may additionally or alternatively employ block Lanczos, Arnoldi-type methods, Jacobi-Davidson methods, direct diagonalization, subspace iteration, inverse iteration, shift-invert schemes, contour-based eigensolvers, filtered subspace methods, polynomial-acceleration methods, quantum phase-estimation workflows, or hybrid classical-quantum workflows. In some embodiments, different solver strategies are used for different spectral ranges, such as low-order extraction, intermediate-band extraction, high-index target-window extraction, or database precomputation. In certain embodiments, different refinement methods are likewise used depending on desired precision, including Rayleigh-quotient refinement, residual minimization, localized subspace correction, or target-window correction. Thus, the present disclosure is not limited to one eigensolver family or one refinement procedure.

In certain embodiments, alternative mappings may be used in the prime-spectral codec system 600. For example, the prime-index mapper 606 may map a prime directly to a spectral index, may map a factorization signature to a tuple of spectral indices, may map a gap sequence to a spectral-gap sequence, may map integer blocks to spectral-coordinate blocks, or may use a hybrid mapping that combines prime indices with auxiliary side information. Likewise, the transform stage 610 may use first differences, higher-order differences, normalized residuals, predictor-based residuals, context-dependent transforms, mixed raw-plus-transformed symbol streams, or another representation suitable for entropy coding. In some embodiments, the entropy coder 612 uses arithmetic coding. In other embodiments, it uses range coding, ANS coding, Huffman coding, adaptive coding, or another lossless coding strategy. In certain embodiments, the codec is configured for maximum compression ratio. In other embodiments, the codec is configured for maximum decoding speed, low-latency streaming, low memory footprint, or remote service operation. Thus, the codec branch of the present disclosure encompasses a broad family of prime-spectral and spectrum-indexed encoding architectures.

In certain embodiments, alternative hardware platforms may be employed. While representative embodiments include the GPU server 702, the FPGA accelerator 704, the ASIC implementation 706, the photonic system 714, the quantum processor 716, and the cloud or distributed-computing environment 724, the disclosed subject matter may also be implemented on one or more CPUs, vector processors, tensor processors, heterogeneous compute clusters, embedded devices, network appliances, edge accelerators, research instruments, or hybrid analog-digital systems. In some embodiments, the same disclosed operator and solver architecture is executed in software on a workstation. In other embodiments, selected tasks are offloaded to hardware accelerators. In still other embodiments, the disclosed subject matter is provided as a service accessed through the network interface 718 by one or more client systems 720. Accordingly, the present disclosure should not be understood as being tied to any single machine architecture.

In certain embodiments, recognition-operator-first embodiments may be employed. In such embodiments, the primary governing relation is not introduced initially as a Schrödinger-type differential operator, but instead as a recognition-evolution relation, stepwise recognition operator, or other recognition-driven update law. An effective Hamiltonian, effective local operator, or effective spectral operator may then be derived under a small-strain, local, quadratic, continuum, or approximation regime. In some embodiments, this permits the disclosed subject matter to retain a broader recognition-theoretic foundation while still supporting practical eigensolver workflows and self-adjoint realizations for selected computational tasks. In certain embodiments, such recognition-operator-first embodiments are useful where the broader system is modeled dynamically, while the spectral extraction procedure uses an effective stationary or reduced operator form.

In certain embodiments, hybrid analog, digital, and quantum embodiments may be employed. For example, one portion of the workflow may be performed by the photonic system 714 to obtain approximate resonant values, another portion may be performed numerically on the GPU server 702 or the FPGA accelerator 704 to refine those values, and another portion may be performed by the quantum processor 716 to evaluate a target subproblem or to narrow a search interval. In some embodiments, the prime-spectral codec system 600 is then driven by the resulting spectral table regardless of how that table was produced. In certain embodiments, the use of hybrid analog-digital or classical-quantum configurations is advantageous where one modality provides speed and another provides precision or flexibility. Accordingly, the present disclosure expressly preserves support for cross-modality execution of the disclosed workflows.

In certain embodiments, alternative target-spectrum embodiments may be employed. For example, the assembled operator 220 may be adapted to target one or more Dirichlet L-functions, one or more Maass-form-related spectra, one or more automorphic spectra, or one or more other number-theoretic spectral targets. In some embodiments, this adaptation is accomplished by weighting the transformed potential output 208, by modifying one or more terms of the assembled operator 220, by changing one or more domain or boundary choices, by altering one or more comparison metrics within the verification and spectral correspondence workflow 500, or by combining one or more of the foregoing. In other embodiments, the operator is left unchanged and is used instead as a surrogate or comparison generator for the selected target spectrum. Thus, the present disclosure is not limited to zeta-only embodiments, even where zeta-zero enumeration is a primary example.

In certain embodiments, alternative validation and benchmark modes may be employed. In some embodiments, direct one-to-one ordinate matching is emphasized. In other embodiments, count matching, spacing-distribution comparison, rigidity comparison, interval testing, residual analysis, or service-level performance testing is emphasized. In some embodiments, one mode of validation is used for research and another for production deployment. In certain embodiments, a low-latency deployment may use prevalidated spectral tables and only limited runtime checks, whereas a certified-generation deployment may perform full correspondence analysis before values are admitted into storage subsystem 722. In this manner, the disclosed subject matter supports flexible qualification standards across different implementations and use cases.

In certain embodiments, the disclosed subject matter may be embodied wholly or partly in software, firmware, hardware, programmable logic, configuration data, service protocols, database structures, network-accessible APIs, or non-transitory computer-readable media storing instructions that cause one or more processors to carry out the disclosed methods. In some embodiments, a user interacts only with an application-level interface while the underlying operator construction, eigensolution, validation, and codec processing occur transparently in the background on one or more local or remote systems. In other embodiments, the disclosed subject matter is exposed as a research environment or toolkit in which users can select domains, solver modes, validation criteria, and codec strategies directly. These software and service variations are all contemplated by the present disclosure.

Accordingly, the present disclosure encompasses numerous alternative embodiments and variations, including but not limited to alternative operator families, alternative transforms of the recognition cost function, alternative domains and boundaries, alternative eigensolvers, alternative codec mappings and coding methods, alternative hardware platforms, recognition-operator-first embodiments, hybrid analog/digital/quantum embodiments, alternative target-spectrum embodiments, and alternative validation and deployment modes. These alternatives may be implemented singly or in combination and are intended to ensure that the present disclosure provides robust written-description and enablement support for a wide range of foreseeable implementations without requiring later continuation-in-part practice merely to capture natural variants of the core disclosed architecture.

The disclosed subject matter provides numerous advantages over conventional approaches to operator-based number-theoretic computation, spectral extraction, and prime-derived data processing. These advantages arise not merely from a single formula or isolated computational routine, but from the disclosed integration of a recognition-derived operator framework, a numerical discretization and eigensolver architecture, a validation and benchmarking architecture, a prime-spectral codec architecture, and a flexible hardware and deployment architecture. In certain embodiments, these advantages are realized individually. In other embodiments, they are realized in combination. The following discussion is illustrative and non-limiting and is intended to highlight representative technical benefits supported by the present disclosure.

In certain embodiments, a first advantage is that the disclosed operator framework is derived from a recognition cost structure rather than being introduced solely as an ad hoc fitted spectral model. In representative embodiments, the transformed potential output 208 is obtained from a recognition cost function through a logarithmic transform, yielding a confining potential usable in the assembled operator 220. In some embodiments, this provides a more unified relationship between the underlying cost structure and the resulting spectral operator than is available in approaches that rely on empirically selected or externally tuned potential shapes. In certain embodiments, the present disclosure therefore provides a technical advantage in derivational coherence while still supporting practical numerical realization.

In certain embodiments, a further advantage is that the disclosed subject matter supports self-adjoint or computationally equivalent realizations through the domain and boundary embodiment 300. By supporting the half-line domain 302, the full-line domain 304, the truncated computational domain 306, the Dirichlet boundary condition 308, the Neumann boundary condition 310, the Robin boundary condition 312, the mixed boundary condition 314, the Friedrichs-extension embodiment 316, and the self-adjoint domain specification 318, the present disclosure provides substantial flexibility in defining realizations that preserve real-spectrum behavior, ordered spectral extraction, and compatibility with symmetric or Hermitian solver workflows. In some embodiments, this flexibility is advantageous during both initial implementation and later prosecution because it avoids confinement to a single narrow realization.

In certain embodiments, an additional advantage is that the disclosed subject matter supports efficient numerical extraction of spectral values through the numerical solver and acceleration workflow 400. The grid construction stage 402, the discretization stage 404, the initial vector stage 406, the Krylov subspace stage 408, the Lanczos recursion stage 410, the reorthogonalization stage 412, the Ritz extraction stage 414, the refinement stage 416, the Toeplitz/FFT acceleration stage 418, the convergence test 420, and the spectral output buffer 422 together provide a structured computational path from operator definition to usable spectral ordinates. In some embodiments, this enables dense extraction, target-window extraction, batch extraction, or table-generation workflows that are computationally practical on modern hardware. In certain embodiments, this constitutes a technical improvement over frameworks that do not provide a similarly integrated operator-to-solver architecture.

In certain embodiments, the technical improvement is not merely that a mathematical expression is evaluated on a general-purpose computer, but that the disclosed workflow organizes operator construction, structured discretization, iterative eigensolution, refinement, validation, and spectral-table reuse in a coordinated architecture that reduces repeated computation and supports practical downstream use of the resulting spectral values in verification and codec pipelines. In some embodiments, this coordinated architecture improves throughput, reduces memory burden, improves reproducibility, and permits the same spectral data structures to be reused across multiple computational stages.

In certain embodiments, a further advantage is that the disclosed subject matter exploits operator structure rather than ignoring it. By using the nonlocal term 214, the Toeplitz kernel 216, the low-rank component 218, the Toeplitz/FFT acceleration stage 418, the shared memory region 708, the FFT engine 710, and the batch-eigensolver architecture 712, the disclosed workflows can reduce computational cost, reduce memory traffic, improve data reuse, and increase throughput. In some embodiments, structured operator application enables repeated matrix-vector products to be performed more efficiently than would be possible using a dense unstructured matrix. In certain embodiments, this advantage becomes especially significant in large-scale spectral-table generation, repeated validation runs, block eigensolver workflows, and codec-table preparation.

In certain embodiments, the disclosed subject matter provides an advantage in that it does not stop at spectral extraction, but instead includes an explicit validation and benchmarking framework. Through the verification and spectral correspondence workflow 500, including the computed spectrum input 502, the reference spectrum input 504, the alignment engine 506, the error engine 508, the spacing-statistics engine 510, the rigidity engine 512, the spectral index 514, the computed ordinate 516, the reference ordinate 518, the count-matching module 520, and the certification output 522, the disclosed subject matter supports direct ordinal comparison, count-based comparison, local statistical comparison, long-range statistical comparison, and performance qualification. In some embodiments, this improves trustworthiness, reproducibility, and deployability relative to systems that compute candidate values without an integrated validation pathway.

In certain embodiments, another significant advantage is that the disclosed subject matter provides a unified prime-spectral codec system 600 rather than treating spectral extraction and compression as unrelated technical domains. By passing prime-derived or integer-derived data through the factorization module 604, the prime-index mapper 606, the spectral lookup 608, the transform stage 610, the entropy coder 612, the compressed output 614, the compressed input 616, the entropy decoder 618, the spectral reconstructor 620, the inverse mapper 622, the integer reconstruction module 624, and the decoded output 626, the disclosed subject matter uses the same recognition-derived spectral architecture for data compression. In some embodiments, this yields lower-entropy representations, more regular transformed symbol streams, improved compressibility of prime-derived datasets, and a unified computational story linking operator theory, spectral indexing, and codec execution.

In certain embodiments, a further advantage is that the same validated spectral architecture supports multiple claim pathways without requiring a change to the disclosed scientific core. In some embodiments, the disclosed operator construction, validation workflow, stored spectral-table architecture, and codec reconstruction workflow provide common support for system claims, method claims, validation claims, compression claims, and deployment claims while remaining rooted in the same recognition-derived cost-function framework.

In certain embodiments, the disclosed subject matter also provides an advantage in hardware adaptability. The GPU server 702, the FPGA accelerator 704, the ASIC implementation 706, the photonic system 714, the quantum processor 716, the network interface 718, the client system 720, the storage subsystem 722, and the cloud or distributed-computing environment 724 together support a broad range of deployments. In some embodiments, this permits the same core operator and codec architecture to be used in local research software, high-throughput accelerator deployments, network-accessible services, streaming compression systems, embedded systems, or hybrid analog-digital and classical-quantum systems. In certain embodiments, this flexibility reduces implementation friction and broadens the practical value of the disclosed subject matter.

In certain embodiments, the disclosed subject matter provides an advantage in prosecution and claim support. Specifically, the present disclosure is structured to support multiple claim pathways, including operator claims, spectral-computation method claims, validation claims, hardware and accelerator claims, codec claims, computer-readable-medium claims, and generalized target-spectrum claims. By expressly supporting local operators, local-plus-nonlocal operators, finite-dimensional matrix realizations, recognition-operator-derived effective operators, alternative domains, alternative boundary conditions, alternative eigensolvers, alternative compression mappings, and alternative hardware deployments, the present disclosure reduces the likelihood that later amendment or claim narrowing would require unsupported new matter. In some embodiments, this breadth advantage is especially important in avoiding continuation-in-part practice merely to capture foreseeable technical variants of the core disclosed architecture.

In certain embodiments, another advantage is that the disclosed subject matter supports generalized target spectra in addition to zeta-target embodiments. Because the operator construction module 106, the numerical solver and acceleration workflow 400, the verification and spectral correspondence workflow 500, and the hardware and deployment embodiments 700 can be adapted for Dirichlet L-functions, Maass-form-related spectra, automorphic spectra, or other target families, the present disclosure is not confined to a single mathematical use case. In some embodiments, this makes the disclosed architecture more technically versatile and more robust as a platform technology.

In certain embodiments, the disclosed subject matter provides a further advantage in that it supports both exact and effective formulations. For example, the specification supports direct Schrödinger-type local operator embodiments as well as recognition-operator-first embodiments in which an effective Hamiltonian or equivalent local spectral operator is obtained through a small-strain, local, quadratic, or continuum approximation. In some embodiments, this dual support is technically valuable because it preserves practical computational workflows while also preserving broader architectural embodiments. In certain embodiments, this makes the disclosed framework more adaptable to future implementation developments without departing from the core disclosure.

Accordingly, in certain embodiments, the disclosed subject matter provides structural advantages, computational advantages, compression advantages, hardware and deployment advantages, validation advantages, and prosecution-support advantages. These include, without limitation, a recognition-derived operator framework, support for self-adjoint or equivalent realizations, efficient numerical workflows, structured operator acceleration, integrated validation, unified prime-spectral compression, multi-platform deployability, generalized target-spectrum adaptability, and broad written-description support for multiple claim families. Taken together, these advantages distinguish the disclosed subject matter from isolated operator proposals, isolated solver pipelines, isolated compression systems, and isolated deployment models, and instead provide a unified technical architecture for recognition-derived spectral computation and prime-spectral data processing.

1. A computational spectral system for generating ordered spectral values associated with number-theoretic structures, the computational spectral system comprising: a memory storing instructions; and one or more processors configured to execute the instructions to: obtain a recognition cost function; apply a coordinate transform to the recognition cost function to generate a transformed potential; construct a spectral operator from at least the transformed potential and a kinetic term; discretize the spectral operator on a computational domain to obtain a finite computational representation; compute ordered spectral values from the finite computational representation using an eigensolver workflow comprising a Krylov-subspace computation; and output the ordered spectral values for comparison with a reference spectrum, validation, storage in a spectral table, transmission, encoding, decoding, or further computation, wherein the recognition cost function is given by J(X)=½(X+1/X)−1, wherein the coordinate transform comprises x=ln(X), and wherein the transformed potential is given by V_RP(x)=J(e\hat{ }x)=cosh(x)−1.

2. The computational spectral system of claim 1, wherein the spectral operator is realized as a self-adjoint operator on a selected domain under one or more selected boundary conditions.

3. The computational spectral system of claim 1, wherein the one or more processors are further configured to execute the instructions to construct the spectral operator to include a nonlocal term represented by or associated with a Toeplitz kernel.

4. The computational spectral system of claim 1, wherein the one or more processors are further configured to execute the instructions to compare at least one of the ordered spectral values with a reference spectrum corresponding to non-trivial zeta-zero ordinates and to determine that the at least one ordered spectral value satisfies a validation criterion when an absolute-error metric, a relative-error metric, or both satisfy a selected threshold.

5. A method for generating ordered spectral values associated with number-theoretic structures, the method comprising: obtaining a recognition cost function; applying a coordinate transform to the recognition cost function to generate a transformed potential; constructing a spectral operator from at least the transformed potential and a kinetic term; discretizing the spectral operator on a computational domain to obtain a finite computational representation; computing ordered spectral values from the finite computational representation using an eigensolver workflow comprising generation of a Krylov subspace; and outputting the ordered spectral values for comparison with a reference spectrum, validation, storage in a spectral table, transmission, encoding, decoding, or further computation, wherein the recognition cost function is given by J(X)=½(X+1/X)−1, wherein the coordinate transform comprises x=ln(X), and wherein the transformed potential is given by V_RP(x)=J(e\hat{ }x)=cosh(x)−1.

6. The method of claim 5, wherein discretizing the spectral operator comprises discretizing the spectral operator on a logarithmic grid.

7. The method of claim 5, wherein computing the ordered spectral values comprises generating a Krylov subspace and performing a Lanczos recursion.

8. The method of claim 5, wherein computing the ordered spectral values further comprises refining at least one of the ordered spectral values using a Rayleigh-quotient refinement.

9. The method of claim 5, further comprising accelerating matrix-vector products associated with the finite computational representation using a Toeplitz or FFT-based acceleration workflow, comparing at least one of the ordered spectral values with a reference spectrum corresponding to non-trivial zeta-zero ordinates, and determining that the at least one ordered spectral value satisfies a validation criterion when an absolute-error metric, a relative-error metric, or both satisfy a selected threshold.

10. A method for compressing data using a prime-spectral codec, the method comprising:
receiving an input sequence comprising prime-derived data, factorization-derived data, or integer-derived data; generating, from the input sequence, one or more prime-related quantities;
mapping the one or more prime-related quantities to ordered spectral values using a prime-index mapper and a spectral lookup, the ordered spectral values being generated from a spectral operator constructed from at least a transformed recognition cost function and a kinetic term;
transforming the ordered spectral values into a coding representation comprising spectral gaps, residuals, differences, or combinations thereof; and entropy coding the coding representation to generate a compressed output.

11. The method of claim 10, wherein generating the one or more prime-related quantities comprises factorizing one or more integers of the input sequence.

12. The method of claim 10, wherein mapping the one or more prime-related quantities to the ordered spectral values comprises mapping one or more prime indices to corresponding ordered spectral values stored in a spectral table generated from the spectral operator constructed from the transformed recognition cost function.

13. The method of claim 10, wherein transforming the one or more spectral quantities into the coding representation comprises generating one or more spectral gaps, first differences, higher-order differences, normalized gaps, or residuals.

14. The method of claim 10, further comprising: receiving a compressed input corresponding to the compressed output; entropy decoding the compressed input to recover decoded coding data;
reconstructing one or more spectral quantities from the decoded coding data; inversely mapping the one or more reconstructed spectral quantities to one or more prime-related quantities;
reconstructing the input sequence to generate a decoded output; verifying that the decoded output is a losslessly reconstructed version of the input sequence; and outputting the decoded output.

15. A hardware accelerator system configured to generate ordered spectral values associated with number-theoretic structures, the hardware accelerator system comprising: one or more processing resources; one or more memory resources; and instructions or logic configured to cause the one or more processing resources to construct or access a spectral operator derived from a transformed recognition cost function, discretize or otherwise realize the spectral operator in finite computational form, compute ordered spectral values from the finite computational form, and output the ordered spectral values for validation, storage, transmission, encoding, decoding, or further computation.

16. The hardware accelerator system of claim 15, wherein the one or more processing resources comprise a GPU server.

17. The hardware accelerator system of claim 15, wherein the one or more processing resources comprise an FPGA accelerator.

18. A non-transitory computer-readable medium storing instructions that, when executed by one or more processors, cause the one or more processors to: obtain a recognition cost function;
apply a coordinate transform to generate a transformed potential; construct or access a spectral operator derived from the transformed potential; discretize or otherwise realize the spectral operator in a finite computational representation; compute ordered spectral values from the finite computational representation; compare the ordered spectral values with a reference spectrum or store the ordered spectral values in a spectral table; and use the ordered spectral values in at least one encoding, decoding, lookup, validation, storage, transmission, or further-computation workflow.

19. The non-transitory computer-readable medium of claim 18, wherein the instructions further cause the one or more processors to perform a prime-spectral codec workflow comprising mapping prime-related quantities to spectral quantities, transforming the spectral quantities into a coding representation, entropy coding the coding representation, entropy decoding a corresponding compressed representation, reconstructing one or more spectral quantities, and reconstructing original data from one or more prime-related quantities.

20. The non-transitory computer-readable medium of claim 18, wherein the instructions further cause the one or more processors to perform at least one of a Krylov-subspace computation, a Lanczos recursion, a Toeplitz or FFT-based structured operator application, a Rayleigh-quotient refinement, a spacing-statistics analysis, a rigidity analysis, or a count-matching analysis.
